(19) United States
(12) Patent Application Publication
(10) Pub. No.: US 2024/0397542 A1
(43) Pub. Date: Nov. 28, 2024

(54) TECHNIQUES FOR CHANNEL STATE INFORMATION COMPRESSION

(71) Applicant: QUALCOMM Incorporated, San Diego, CA (US)

(72) Inventors: Ahmed ELSHAFIE, San Diego, CA (US); Muhammad Sayed Khairy ABDELGHAFFAR, San Jose, CA (US); Yu ZHANG, San Diego, CA (US)

(21) Appl. No.: 18/693,467

(22) PCT Filed: Nov. 16, 2021
(86) PCT No.: PCT/CN2021/130889

§ 371 Date: Mar. 19, 2024

(51) Int. Cl. H04W 72/542; H04L 5/00

(52) U.S. Cl. CPC H04W 72/542; H04L 5/0048

(57) ABSTRACT

Methods, systems, and devices for wireless communications are described. A user equipment (UE) and a base station may communicate a set of downlink messages. In some examples, the UE may transmit a message including an indication of a level of correlation between a set of channel metrics associated with the plurality of downlink messages. In some examples, the UE may receive, from the base station, control signaling configuring at least a first resource for reporting channel state information having a first level of compression and a second resource for reporting channel state information having a second level of compression. The UE may communicate with the base station based on the control signaling, the indication, or a combination thereof. In some examples, the UE may cancel a report message or transmit a report message indicating the set of channel metrics in accordance with a level of compression.

### CROSS REFERENCE

The present Application is a 371 national stage filing of International PCT Application No. PCT/CN2021/130889 by ELSHAFIE et al. entitled “TECHNIQUES FOR CHANNEL STATE INFORMATION COMPRESSION,” filed Nov. 16, 2021, which is assigned to the assignee hereof, and which is expressly incorporated by reference in its entirety herein.

### FIELD OF TECHNOLOGY

The following relates to wireless communications, including techniques for channel state information compression.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

In some wireless communication systems, a wireless device may report channel state information indicating a quality of the channel, which may enable the devices in the system to improve communications efficiency, reliability, or both. However, current techniques for reporting channel information may be deficient.

### SUMMARY

The described techniques relate to improved methods, systems, devices, and apparatuses that support techniques for channel state information (CSI) compression. Generally, the described techniques provide for an indication of a level of correlation between channel metrics (e.g., CSI reports), compression of CSI reports, cancelation of CSI reports, or any combination thereof. For example, a user equipment (UE) may receive a set of downlink messages from a base station. The UE may determine a level of correlation between channel metrics of a set of channel metrics associated with the set of downlink messages. In some examples, the UE may determine whether the level of correlation satisfies a threshold (e.g., whether the channel metrics are relatively highly correlated). In some examples, the UE may transmit an indication of the level of correlation to a base station. Additionally or alternatively, the UE may select resources for reporting the channel metrics based on the level of correlation. The UE may transmit, and the base station may receive, a report (e.g., a CSI report) based on the indication or the selected resources, or both. For example, the UE may transmit a compressed report or cancel the report of the channel metrics if the threshold is satisfied (e.g., when the channel metrics are relatively highly correlated). In some cases, the UE may transmit the compressed report over the selected resources configured for communicating compressed reports. In some other examples, the UE may transmit a full report if the threshold is not satisfied (e.g., when the channel metrics are relatively uncorrelated). For example, the UE may transmit a full report over selected resources configured for communicating full reports.

A method for wireless communications at a UE is described. The method may include receiving a set of multiple downlink messages from a base station, transmitting, to the base station, a message including an indication of a level of correlation between a set of channel metrics associated with the set of multiple downlink messages, and communicating with the base station based on transmitting the message including the indication of the level of correlation between the set of channel metrics.

An apparatus for wireless communications at a UE is described. The apparatus may include a processor, memory coupled with the processor, and instructions stored in the memory. The instructions may be executable by the processor to cause the apparatus to receive a set of multiple downlink messages from a base station, transmit, to the base station, a message including an indication of a level of correlation between a set of channel metrics associated with the set of multiple downlink messages, and communicate with the base station based on transmitting the message including the indication of the level of correlation between the set of channel metrics.

Another apparatus for wireless communications at a UE is described. The apparatus may include means for receiving a set of multiple downlink messages from a base station, means for transmitting, to the base station, a message including an indication of a level of correlation between a set of channel metrics associated with the set of multiple downlink messages, and means for communicating with the base station based on transmitting the message including the indication of the level of correlation between the set of channel metrics.

A non-transitory computer-readable medium storing code for wireless communications at a UE is described. The code may include instructions executable by a processor to receive a set of multiple downlink messages from a base station, transmit, to the base station, a message including an indication of a level of correlation between a set of channel metrics associated with the set of multiple downlink messages, and communicate with the base station based on transmitting the message including the indication of the level of correlation between the set of channel metrics.

In some examples of the method, apparatuses, and non-transitory computer-readable medium described herein, communicating with the base station may include operations, features, means, or instructions for transmitting a report message indicating at least a portion of the set of channel metrics based on whether the level of correlation between the set of channel metrics satisfies a threshold.

In some examples of the method, apparatuses, and non-transitory computer-readable medium described herein, the report message indicates a subset of channel metrics from the set of channel metrics, a single channel metric for a group of the set of channel metrics, or each channel metric of the set of channel metrics based on whether the level of correlation satisfies the threshold.

Some examples of the method, apparatuses, and non-transitory computer-readable medium described herein may further include operations, features, means, or instructions for cancelling a report message for indicating the set of channel metrics based on the level of correlation between the set of channel metrics satisfying a threshold.

In some examples of the method, apparatuses, and non-transitory computer-readable medium described herein, transmitting the message may include operations, features, means, or instructions for transmitting the message including the indication of the level of correlation in a first stage uplink control information message, the message indicating a report size for a second stage uplink control information message including at least a portion of CSI.

In some examples of the method, apparatuses, and non-transitory computer-readable medium described herein, the first stage uplink control information message indicates a same compression level for a set of multiple second stage uplink control information messages within a window.

Some examples of the method, apparatuses, and non-transitory computer-readable medium described herein may further include operations, features, means, or instructions for receiving control signaling from the base station indicating a duration of the window.

Some examples of the method, apparatuses, and non-transitory computer-readable medium described herein may further include operations, features, means, or instructions for receiving control signaling indicating a first set of resources associated with a compressed report for reporting the set of channel metrics and a second set of resources associated with a full report for reporting the set of channel metrics and transmitting the compressed report via the first set of resources or the full report via the second set of resources based on the message including the indication.

In some examples of the method, apparatuses, and non-transitory computer-readable medium described herein, the level of correlation satisfies a threshold and the method, apparatuses, and non-transitory computer-readable medium may include further operations, features, means, or instructions for transmitting a compressed report based on the level of correlation satisfying the threshold and cancelling a full report based on the level of correlation satisfying the threshold.

In some examples of the method, apparatuses, and non-transitory computer-readable medium described herein, the level of correlation fails to satisfy a threshold and the method, apparatuses, and non-transitory computer-readable medium may include further operations, features, means, or instructions for transmitting a full report based on the level of correlation failing to satisfy the threshold.

In some examples of the method, apparatuses, and non-transitory computer-readable medium described herein, the indication of the level of correlation corresponds to a first compression level of a set of multiple compression levels.

Some examples of the method, apparatuses, and non-transitory computer-readable medium described herein may further include operations, features, means, or instructions for receiving control signaling from the base station indicating the set of multiple compression levels and selecting the first compression level based on the level of correlation, where transmitting the message including the indication may be based on the selecting.

In some examples of the method, apparatuses, and non-transitory computer-readable medium described herein, each of the set of multiple compression levels corresponds to a respective resource, the respective resource having a size associated with a respective compression level of the set of multiple compression levels.

A method for wireless communications at a base station is described. The method may include transmitting a set of multiple downlink messages to a UE, receiving, from the UE, a message including indication of a level of correlation between a set of channel metrics associated with the set of multiple downlink messages, and communicating with the UE based on receiving the message including the indication of the level of correlation between the set of channel metrics.

An apparatus for wireless communications at a base station is described. The apparatus may include a processor, memory coupled with the processor, and instructions stored in the memory. The instructions may be executable by the processor to cause the apparatus to transmit a set of multiple downlink messages to a UE, receive, from the UE, a message including indication of a level of correlation between a set of channel metrics associated with the set of multiple downlink messages, and communicate with the UE based on receiving the message including the indication of the level of correlation between the set of channel metrics.

Another apparatus for wireless communications at a base station is described. The apparatus may include means for transmitting a set of multiple downlink messages to a UE, means for receiving, from the UE, a message including indication of a level of correlation between a set of channel metrics associated with the set of multiple downlink messages, and means for communicating with the UE based on receiving the message including the indication of the level of correlation between the set of channel metrics.

A non-transitory computer-readable medium storing code for wireless communications at a base station is described. The code may include instructions executable by a processor to transmit a set of multiple downlink messages to a UE, receive, from the UE, a message including indication of a level of correlation between a set of channel metrics associated with the set of multiple downlink messages, and communicate with the UE based on receiving the message including the indication of the level of correlation between the set of channel metrics.

Some examples of the method, apparatuses, and non-transitory computer-readable medium described herein may further include operations, features, means, or instructions for refraining from monitoring for a report message indicating the set of channel metrics based on the level of correlation between the set of channel metrics satisfying a threshold.

In some examples of the method, apparatuses, and non-transitory computer-readable medium described herein, communicating with the UE may include operations, features, means, or instructions for receiving a report message indicating at least a portion of the set of channel metrics based on whether the level of correlation between the set of channel metrics satisfies a threshold.

In some examples of the method, apparatuses, and non-transitory computer-readable medium described herein, the report message indicates a subset of channel metrics from the set of channel metrics, a single channel metric for a group of the set of channel metrics, or each channel metric of the set of channel metrics based on whether the level of correlation satisfies the threshold.

In some examples of the method, apparatuses, and non-transitory computer-readable medium described herein, receiving the message may include operations, features, means, or instructions for receiving the message including the indication of the level of correlation in a first stage uplink control information message, the message indicating a report size for a second stage uplink control information message including at least a portion of CSI.

In some examples of the method, apparatuses, and non-transitory computer-readable medium described herein, the first stage uplink control information message indicates a same compression level for a set of multiple second stage uplink control information messages within a window and the method, apparatuses, and non-transitory computer-readable medium may include further operations, features, means, or instructions for transmitting control signaling to the UE indicating a duration of the window.

Some examples of the method, apparatuses, and non-transitory computer-readable medium described herein may further include operations, features, means, or instructions for transmitting control signaling indicating a first set of resources associated with a compressed report for reporting the set of channel metrics and a second set of resources associated with a full report for reporting the set of channel metrics and receiving the compressed report via the first set of resources or the full report via the second set of resources based on the message including the indication.

In some examples of the method, apparatuses, and non-transitory computer-readable medium described herein, the level of correlation satisfies a threshold and the method, apparatuses, and non-transitory computer-readable medium may include further operations, features, means, or instructions for receiving a compressed report based on the level of correlation satisfying the threshold and refraining from monitoring for a full report based on the level of correlation satisfying the threshold.

In some examples of the method, apparatuses, and non-transitory computer-readable medium described herein, the level of correlation fails to satisfy a threshold and the method, apparatuses, and non-transitory computer-readable medium may include further operations, features, means, or instructions for receiving a full report based on the level of correlation failing to satisfy the threshold.

In some examples of the method, apparatuses, and non-transitory computer-readable medium described herein, the indication of the level of correlation corresponds to a first compression level of a set of multiple compression levels.

Some examples of the method, apparatuses, and non-transitory computer-readable medium described herein may further include operations, features, means, or instructions for transmitting control signaling to the UE indicating the set of multiple compression levels.

In some examples of the method, apparatuses, and non-transitory computer-readable medium described herein, each of the set of multiple compression levels corresponds to a respective resource, the respective resource having a size associated with a respective compression level of the set of multiple compression levels.

A method for wireless communications at a UE is described. The method may include receiving, from a base station, control signaling indicating at least a first resource for reporting CSI having a first level of compression and a second resource for reporting the CSI having a second level of compression, receiving a set of multiple downlink messages from the base station, and transmitting, to the base station, a message indicating a set of channel metrics associated with the set of multiple downlink messages via the first resource or the second resource based on a level of correlation between the set of channel metrics.

An apparatus for wireless communications at a UE is described. The apparatus may include a processor, memory coupled with the processor, and instructions stored in the memory. The instructions may be executable by the processor to cause the apparatus to receive, from a base station, control signaling indicating at least a first resource for reporting CSI having a first level of compression and a second resource for reporting the CSI having a second level of compression, receive a set of multiple downlink messages from the base station, and transmit, to the base station, a message indicating a set of channel metrics associated with the set of multiple downlink messages via the first resource or the second resource based on a level of correlation between the set of channel metrics.

Another apparatus for wireless communications at a UE is described. The apparatus may include means for receiving, from a base station, control signaling indicating at least a first resource for reporting CSI having a first level of compression and a second resource for reporting the CSI having a second level of compression, means for receiving a set of multiple downlink messages from the base station, and means for transmitting, to the base station, a message indicating a set of channel metrics associated with the set of multiple downlink messages via the first resource or the second resource based on a level of correlation between the set of channel metrics.

A non-transitory computer-readable medium storing code for wireless communications at a UE is described. The code may include instructions executable by a processor to receive, from a base station, control signaling indicating at least a first resource for reporting CSI having a first level of compression and a second resource for reporting the CSI having a second level of compression, receive a set of multiple downlink messages from the base station, and transmit, to the base station, a message indicating a set of channel metrics associated with the set of multiple downlink messages via the first resource or the second resource based on a level of correlation between the set of channel metrics.

In some examples of the method, apparatuses, and non-transitory computer-readable medium described herein, the first resource includes a different resource than the second resource or a same resource as the second resource.

A method for wireless communications at a base station is described. The method may include transmitting, to a UE, control signaling indicating at least a first resource for reporting CSI having a first level of compression and a second resource for reporting the CSI having a second level of compression, transmitting a set of multiple downlink messages to the UE, and receiving, from the UE, message indicating a set of channel metrics associated with the set of multiple downlink messages via the first resource or the second resource based on a level of correlation between the set of channel metrics.

An apparatus for wireless communications at a base station is described. The apparatus may include a processor, memory coupled with the processor, and instructions stored in the memory. The instructions may be executable by the processor to cause the apparatus to transmit, to a UE, control signaling indicating at least a first resource for reporting CSI having a first level of compression and a second resource for reporting the CSI having a second level of compression, transmit a set of multiple downlink messages to the UE, and receive, from the UE, message indicating a set of channel metrics associated with the set of multiple downlink messages via the first resource or the second resource based on a level of correlation between the set of channel metrics.

Another apparatus for wireless communications at a base station is described. The apparatus may include means for transmitting, to a UE, control signaling indicating at least a first resource for reporting CSI having a first level of compression and a second resource for reporting the CSI having a second level of compression, means for transmitting a set of multiple downlink messages to the UE, and means for receiving, from the UE, message indicating a set of channel metrics associated with the set of multiple downlink messages via the first resource or the second resource based on a level of correlation between the set of channel metrics.

A non-transitory computer-readable medium storing code for wireless communications at a base station is described. The code may include instructions executable by a processor to transmit, to a UE, control signaling indicating at least a first resource for reporting CSI having a first level of compression and a second resource for reporting the CSI having a second level of compression, transmit a set of multiple downlink messages to the UE, and receive, from the UE, message indicating a set of channel metrics associated with the set of multiple downlink messages via the first resource or the second resource based on a level of correlation between the set of channel metrics.

In some examples of the method, apparatuses, and non-transitory computer-readable medium described herein, the first resource includes a different resource than the second resource.

In some examples of the method, apparatuses, and non-transitory computer-readable medium described herein, the first resource includes a same resource as the second resource and the method, apparatuses, and non-transitory computer-readable medium may include further operations, features, means, or instructions for decoding the message indicating the set of channel metrics in accordance with a first compression level and decoding the message indicating the set of channel metrics in accordance with a second compression level.

### BRIEF DESCRIPTION OF THE DRAWINGS

FIG. 1 illustrates an example of a wireless communications system that supports techniques for channel state information compression in accordance with aspects of the present disclosure.

FIG. 2 illustrates an example of a wireless communications system that supports techniques for channel state information compression in accordance with aspects of the present disclosure.

FIG. 3 illustrates an example of reporting schemes that support techniques for channel state information compression in accordance with aspects of the present disclosure.

FIGS. 4 and 5 illustrate examples of feedback schemes that support techniques for channel state information compression in accordance with aspects of the present disclosure.

FIGS. 6-8 illustrate examples of process flows in a system that support techniques for channel state information compression in accordance with aspects of the present disclosure.

FIG. 9 illustrates an example of a reporting scheme that supports techniques for channel state information compression in accordance with aspects of the present disclosure.

FIG. 10 illustrates an example of a process flow in a system that supports techniques for channel state information compression in accordance with aspects of the present disclosure.

FIGS. 11 and 12 show block diagrams of devices that support techniques for channel state information compression in accordance with aspects of the present disclosure.

FIG. 13 shows a block diagram of a communications manager that supports techniques for channel state information compression in accordance with aspects of the present disclosure.

FIG. 14 shows a diagram of a system including a device that supports techniques for channel state information compression in accordance with aspects of the present disclosure.

FIGS. 15 and 16 show block diagrams of devices that support techniques for channel state information compression in accordance with aspects of the present disclosure.

FIG. 17 shows a block diagram of a communications manager that supports techniques for channel state information compression in accordance with aspects of the present disclosure.

FIG. 18 shows a diagram of a system including a device that supports techniques for channel state information compression in accordance with aspects of the present disclosure.

FIGS. 19 through 22 show flowcharts illustrating methods that support techniques for channel state information compression in accordance with aspects of the present disclosure.

### DETAILED DESCRIPTION

Some wireless communications systems may support channel feedback, such as channel state information (CSI) feedback. For example, a base station may send downlink messages to a user equipment (UE). The downlink messages may include reference signals (e.g., CSI reference signals (RSs)). The UE may estimate channel conditions using the reference signals. For example, the UE may obtain channel metrics (e.g., parameters of CSI reports) indicating a quality of the channel. The UE may report the channel metrics for the downlink messages. In some examples, the UE may transmit a report subsequent to each downlink message. In some other examples, the UE may receive multiple messages and transmit a single report for the multiple messages. However, in some cases the UE may accumulate a relatively large quantity of channel metrics for transmission in a single CSI report. In such cases, the relatively large payload size may result in relatively poor communications efficiency or reliability.

Accordingly, devices may support improved techniques for CSI as described herein. Such techniques may enable the devices to compress or cancel report messages, indicate a level of correlation and/or compression of a report message, or any combination thereof. For example, a UE may determine a level of correlation between channel metrics associated with a set of downlink messages. In some examples, the UE may determine whether the level of correlation satisfies a threshold (e.g., whether the channel metrics are relatively highly correlated). A level of correlation may additionally or alternatively be referred to as a degree of correlation, a metric indicating a correlation (e.g., a quantity of metrics having a same or similar type, value, etc.), and the like. The channel metrics may be referred to as CSI reports, channel parameters, and the like. As an example, a UE may determine that a quantity of channel metrics have same or similar parameters (e.g., a same or similar precoding matrix indication (PMI), channel quality indicator (CQI), a rank indication (RI), a received signal received power (RSRP), or any combination thereof, among other examples of channel metrics). The UE may compare the quantity of channel metrics that are correlated to one or more thresholds and determine a level of correlation based on the comparison.

In some examples, the UE may transmit an indication of the level of correlation to the base station. For example, the UE may indicate whether the set of metrics satisfy a threshold (e.g., whether the metrics have a relatively high level of correlation or a relatively low level of correlation, though any quantity of levels may be used). Stated alternatively, the UE may indicate a level of compression for a corresponding report of the channel metrics. As an illustrative example, the UE may indicate a first value (e.g., a bit with a value of 0 or 1) if the reports have a relatively high level of correlation. In such examples, the UE may cancel a report or transmit a compressed report. For example, the UE may transmit a report indicating a single channel metric corresponding to multiple downlink messages from the base station or a report indicating a subset of the channel metrics. In some other examples, the UE may indicate a second value if the reports have a relatively low level of correlation. In such examples, the UE may transmit a full report (e.g., a report indicating each of the channel metrics).

Additionally or alternatively, the UE may select resources for reporting the channel metrics based on the level of correlation. For example, the base station may transmit control signaling indicating first resources for a first level of correlation (e.g., resources for transmitting reports with a first level of compression that corresponds to the first level of correlation), second resources for a second level of correlation, and so on. The UE may transmit on the indicated resources based on the determined level of correlation of the channel metrics. In some examples, the UE may transmit the indication of the level of correlation in a first feedback stage and transmit on the selected resources in a second feedback stage. In some other examples, the UE may not transmit an indication. For example, the UE may transmit on difference resources for different levels of compression and the base station may determine the level of correlation or compression based on the resources carrying the report. Additionally or alternatively, the UE may transmit on the same resources (e.g., the first resources and second resources may be the same resources) and the base station may decode the report multiple times using a different compression level each time.

The techniques described herein may be implemented to realize one or more potential benefits. For example, by transmitting a compressed report or cancelling a report for metrics having a relatively high level of correlation, the UE may reduce signaling overhead when reporting CSI (e.g., without losing information for the downlink messages due to the indication of the level of compression or selected resources indicating to the base station that a single channel metric may apply to multiple downlink messages). Additionally or alternatively, a UE may transmit a full report for relatively low correlation levels, which may improve accuracy of CSI reporting at the base station.

Aspects of the disclosure are initially described in the context of wireless communications systems. Aspects of the disclosure are then described in the context of reporting schemes, feedback schemes, and process flows. Aspects of the disclosure are further illustrated by and described with reference to apparatus diagrams, system diagrams, and flowcharts that relate to techniques for channel state information compression.

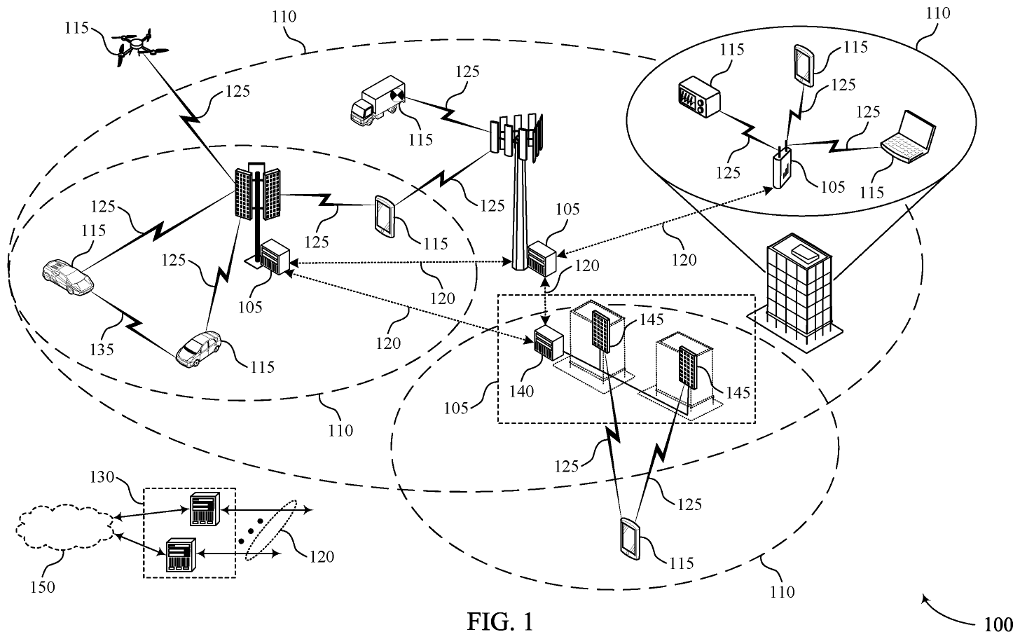

FIG. 1 illustrates an example of a wireless communications system 100 that supports techniques for channel state information compression in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (STTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, for example, in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

The base stations 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the medium access control (MAC) layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

The wireless communications system 100 may support techniques for improved CSI as described herein. For example, a UE 115 may receive a set of downlink messages from a base station 105. The UE 115 may determine a level of correlation between channel metrics of a set of channel metrics associated with the set of downlink messages. In some examples, the UE 115 may determine whether the level of correlation satisfies a threshold (e.g., whether the channel metrics are relatively highly correlated). In some examples, the UE 115 may transmit an indication of the level of correlation to a base station 105. Additionally or alternatively, the UE 115 may select resources for reporting the channel metrics based on the level of correlation. The UE 115 may transmit, and the base station 105 may receive, a report based on the indication or the selected resources or both. For example, the UE 115 may transmit a compressed report or cancel the report of the channel metrics if the threshold is satisfied. In some cases, the UE 115 may transmit the compressed report over the selected resources configured for communicating compressed reports. In some other examples, the UE 115 may transmit a full report if the threshold is not satisfied. For example, the UE 115 may transmit a full report over selected resources configured for communicating full reports.

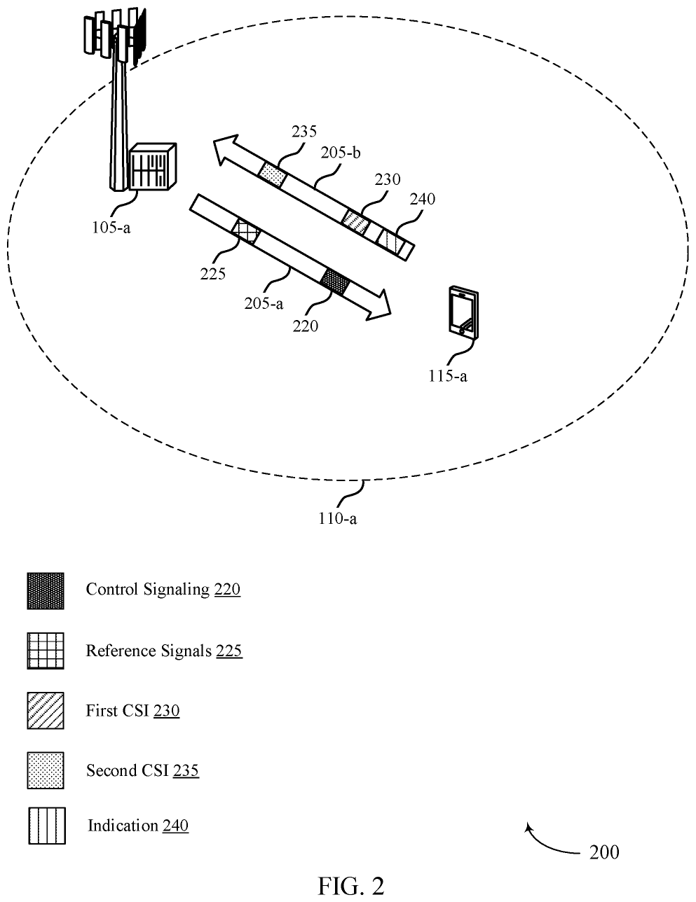

FIG. 2 illustrates an example of a wireless communications system 200 that supports techniques for channel state information compression in accordance with aspects of the present disclosure. In some examples, the wireless communications system 200 may implement aspects of wireless communications system 100. For example, the wireless communications system 200 may include UE 115-a and base station 105-a, which may be respective examples of a UE 115 and a base station 105 described with reference to FIG. 1.

The wireless communications system 200 may support channel feedback, such as CSI feedback. For example, the base station 105-a may send downlink messages to the UE 115-a via the communication link 205-a, which may be an example of a communication link as described with reference to FIG. 1. The downlink messages may include reference signals 225. The reference signals 225 may be examples of CSI-RSs or any other type of reference signals. The UE 115-a may receive the reference signals 225 and estimate channel conditions based on the reference signals 225. For example, the UE 115-a may obtain channel metrics associated with the downlink messages that indicate a quality of the channel. As illustrative examples, the channel metrics may include an RSRP of the reference signals 225 (e.g., L1-RSRP), a CQI, an RI, or other parameters that indicate channel conditions (e.g., metrics indicating an amount of noise in the channel, a throughput of the channel, etc.). The channel metrics may be an example of or included in CSI, such as the first CSI 230 and the second CSI 235.

The UE 115-a may report the channel metrics in one or more report messages as described herein (e.g., CSI reports) via the communications link 205-b. For example, the UE may transmit a report in response to each downlink message (e.g., a report with first CSI 230 for a first downlink message, a second report with second CSI 235 for a second downlink message, and so on). Additionally or alternatively, the UE may transmit a report for multiple downlink messages (e.g., the UE may transmit a single report message including the first CSI 230 for a first downlink message, a second report with second CSI 235 for a second downlink message, and so on). In such examples, the UE may obtain one or more channel metrics for each downlink message (e.g., each reference signal 225) and send a set of channel metrics for a set of downlink messages in a single report message. However, in some cases the UE 115-a may accumulate a relatively large quantity of channel metrics for transmission in the single report. In such cases, the relatively large payload size may result in relatively poor communications efficiency or reliability, or both.

Accordingly, the wireless communications system 200 may support improved techniques for channel feedback as described herein. Such techniques may enable the devices to compress or cancel report messages, indicate a level of correlation and/or compression of a report message, or any combination thereof. For example, the UE 115-a may determine a level of correlation between channel metrics associated with a set of downlink messages. In some examples, the UE 115-a may determine whether the level of correlation satisfies a threshold (e.g., whether the channel metrics are relatively highly correlated). A level of correlation may additionally or alternatively be referred to as a degree of correlation, a metric indicating a correlation (e.g., a quantity or percentage of metrics having a same or similar type, value, etc.), and the like. The channel metrics may be referred to as CSI reports, channel parameters, and the like. As an example, the UE 115-a may determine that a threshold quantity of channel metrics have same or similar parameters (e.g., parameters within a threshold range). The UE 115-a may compare the quantity of channel metrics that are correlated to one or more thresholds and determine a level of correlation based on the comparison. Other methods for determining a level of correlation may additionally or alternatively be used (e.g., determining whether an average or standard deviation of the metrics satisfy one or more thresholds).

In some examples, the UE 115-a may transmit an indication 240 of the level of correlation to the base station 105-a. For example, the UE 115-a may send the indication 240 of whether the set of metrics satisfy a threshold (e.g., whether the metrics have a high level of correlation or a low level of correlation, though any quantity of levels of correlation may be used).

As an illustrative example, the UE 115-a may indicate a first value (e.g., a bit with a value of 0 or 1) if the reports have a relatively high level of correlation. In such examples, the UE 115-a may cancel a report or transmit a compressed report. As an illustrative example, the UE 115-a may transmit a report indicating a single channel metric corresponding to multiple downlink messages or a report indicating a subset of the channel metrics, although any quantity or type of compression schemes may be used. For example, the UE 115-a may remove a channel metric from the set of channel metrics in a configured interval (e.g., every other channel metric, every third channel metric, etc.), the UE 115-a may report a single channel metric for all of the downlink messages, the UE 115-a may cancel a report, the UE 115-a may remove some information from a report (e.g., PMI, RI, CQI, synchronization block (SB) CQI, and the like), or any combination thereof. By compressing or canceling a report for high correlation CSI reports (e.g., channel metrics), the UE 115-a may reduce signaling overhead while maintaining relatively accurate CSI reporting.

As another illustrative example, the UE 115-a may indicate a second value (e.g., a bit with a value of 0 or 1) if the reports have a relatively low level of correlation. In such examples, the UE 115-a may transmit a full report (e.g., a report indicating each of the channel metrics). By transmitting a full report, the UE 115-a may retain accurate CSI reporting for each of the downlink messages.

The indication 240 may be an example of a field in an uplink message (e.g., a bit or a set of bits in the uplink message). For example, the indication 240 may be included in an uplink control message (e.g., a physical uplink control channel (PUCCH) message). In some examples, the indication 240 may be included in a first stage (e.g., Stage 1) of a feedback process. For example, the UE 115-a may transmit a first stage feedback message with the indication 240 (e.g., the first stage may be 1 bit) and transmit a second stage feedback message (e.g., Stage 2) with the corresponding CSI (e.g., the second stage may include X bits for indicating the set of channel metrics). The second stage may occur after the first stage and the resources, timing, information, and the like of the second stage feedback message may be based on the first stage feedback message.

In some examples, the indication 240 may be an example of a “CancelFlag” field. For example, the indication 240 may indicate a first value (e.g., a bit value of 0) if the set of metrics are relatively uncorrelated (e.g., the set of metrics fail to satisfy a correlation threshold), and a second value (e.g., a bit value of 1) if the set of metrics are relatively correlated (e.g., the set of metrics satisfy the correlation threshold). Though a 1 bit field is given as an illustrative example, it is to be understood that any quantity of bits may be used. In some examples, in addition or alternative to indicating a level of correlation between a set of channel metrics, the indication 240 may indicate a level of compression for the set of channel metrics in a respective feedback message, a size of the respective feedback message based on the level of compression or correlation, or any combination thereof, among other examples of indications. In some examples, multiple compression schemes may be configured at the UE 115-a and the base station 105-a, and the indication 240 may indicate which compression scheme is being used for a corresponding feedback message.

In addition or alternative to the indication 240, the wireless communications system 200 may support resources configured for various levels of correlations (e.g., different or same resources may support various levels of compression). For example, the UE 115-a may select resources for reporting the channel metrics based on the level of correlation. The resources may be configured via control signaling 220. For example, the base station 105-a may transmit the control signaling 220 indicating first resources for a first level of correlation (e.g., resources for transmitting reports with a first level of compression that corresponds to the first level of correlation), second resources for a second level of correlation, and so on. In some examples, the control signaling 220 may include downlink control information (DCI), MAC control element (CE) signaling, radio resource control (RRC) signaling, or any combination thereof, among other examples of control signaling.

In some examples, the first resources may have a size that corresponds to the first compression level (e.g., the first resources may accommodate a relatively large amount of CSI feedback bits in the first CSI 230 if no compression or a relatively small amount of compression is used), the second resources may have a second size that corresponds to the second compression level (e.g., the second resources may have a smaller size while still accommodating a relatively small amount of CSI feedback bits in the second CSI 235 if a high amount or level of compression is used), and the like.

Thus, the UE 115-a may transmit a report message on a set of resources corresponding to the level of correlation of the set of channel metrics associated with the report message. In some examples, the UE 115-a may transmit the indication 240 in addition to transmitting a report message on resources corresponding to the level of correlation or compression. In some other examples, the UE 115-a may not transmit the indication 240. For example, the UE 115-a may transmit report messages with a first compression level (e.g., corresponding to a first level of correlation) on first resources configured for report messages having the first compression level, the UE 115-a may transmit report messages with a second compression level on second resources configured for report messages having the second compression level, and so on. If the resources are different, the base station 105-a may monitor both resources and select a compression level or scheme for decoding the report messages based on which resources were used. Alternatively, if the resources are the same resources, the base station 105-a may decode a report message multiple times. For example, the base station 105-a may decode a report message using a first compression scheme, and if the decoding fails, the base station 105-a may try different compression schemes until the decoding is successful.

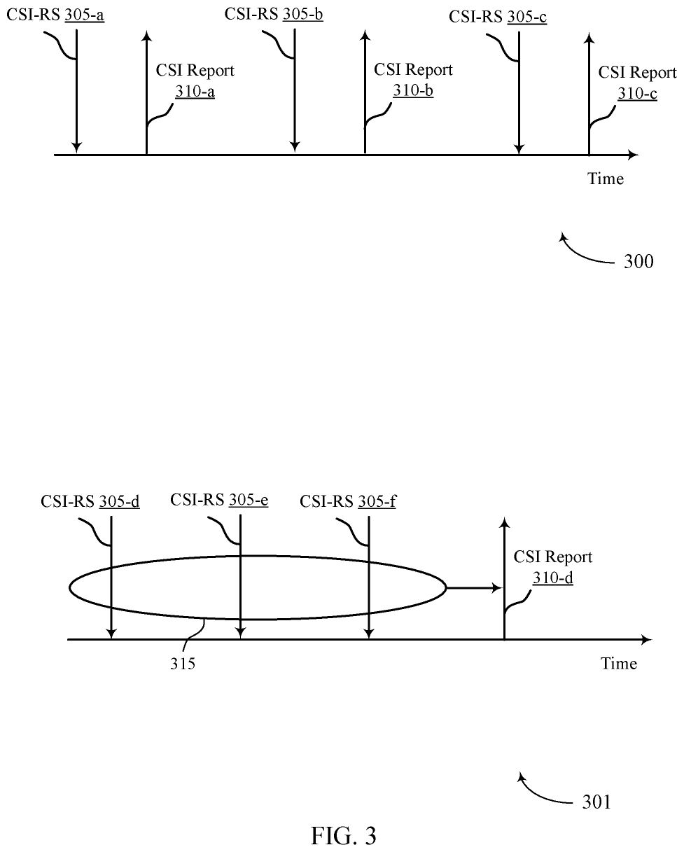

FIG. 3 illustrates an example of reporting schemes 300 and 301 that support techniques for channel state information compression in accordance with aspects of the present disclosure. The reporting schemes 300 and 301 may implement or be implemented by aspects of wireless communications systems 100 and 200 as described herein with reference to FIGS. 1 and 2. For example, the reporting schemes 300 and 301 may illustrate communications between a UE 115 and a base station 105, though the techniques described herein may be implemented by any quantity or type of wireless devices.

The reporting schemes 300 and 301 includes CSI-RSs 305 and CSI reports 310. The CSI-RSs 305 may be examples of the reference signals 225 as described with reference to FIG. 2. The CSI reports 310 may be examples of the first CSI 230, the second CSI 235, or both as described with reference to FIG. 2. For example, the CSI reports 310 may be uplink messages including one or more channel metrics.

In the example of reporting scheme 300, a UE may receive the CSI-RS 305-a, the CSI-RS 305-b, and the CSI-RS 305-c, for example, in downlink messages from a base station. The UE may use multiple CSI reports 310 for the CSI-RSs 305-a. For example, the UE may indicate one or more channel metrics for the CSI-RS 305-a (e.g., a first downlink message) in the CSI report 310-a, one or more channel metrics for the CSI-RS 305-b (e.g., a second downlink message) in the CSI report 310-b, and one or more channel metrics for the CSI-RS 305-c (e.g., a third downlink message) in the CSI report 310-c. In some examples, the multiple CSI reports 310 may be differential-based CSI reports. For example, the CSI report 310-a may indicate a channel metric and the CSI report 310-b may indicate a difference (e.g., a delta) between the channel metric of the CSI report 310-a and a channel metric of the CSI report 310-b, which may reduce a signaling overhead.

In the example of reporting scheme 301, a UE may receive a group 315 of CSI-RSs 305. The group 315 may include the CSI-RS 305-d, the CSI-RS 305-e, and the CSI-RS 305-f. The UE may transmit a single CSI report 310-d including channel metrics for each CSI-RS 305 in the group 315. In some examples, such a report may use time domain compression. For example, a base station may use time correlation to predict or estimate the physical downlink shared channel (PDSCH) channel for the set of channel metrics for the group 315. By using a single report for the group 315, uplink signaling overhead may be decreased. However, in some cases the CSI report 310-d may be relatively large (e.g., the UE may accumulate a relatively large quantity of channel metrics for the group 315), and reliability and/or efficiency may be reduced.

Accordingly, the reporting schemes 300 and 301 may support the feedback techniques as described herein. For example, the UE may compress the CSI report 310-d, cancel the CSI report 310-d, or transmit a full CSI report 310-d based on a level of correlation between the channel metrics for the group 315, as described with reference to FIG. 2. The UE may additionally or alternatively transmit an indication (e.g., the indication 240) of the level of correlation or compression of the channel metrics for the CSI report 310-d. In some examples, the UE may transmit the CSI report 310-d via resources configured for a respective level of correlation as described herein.

In some examples, the UE may cancel a CSI report 310 or a behavior of the UE (e.g., a type of report or a level of compression) based on one or more of the channel metrics being relatively correlated (e.g., several metrics have a same or similar CSI, such as a same or similar PMI, CQI, RI, L1-RSRP, and the like). In some such examples, the contents of the CSI report 310 may be different based on whether reports are highly correlated or not (e.g., different levels of compression may be used for different levels of correlation). The techniques described herein may enable a UE to cancel or send a different CSI report 310 if the channel metrics relatively highly correlated. Additionally or alternatively, the UE may signal a level of compression or correlation from multiple levels of compression or correlation (e.g., levels of compression or correlation may be pre-configured at the UE and base station or configured via control signaling), and the CSI report 310 may be prepared according to such a compression level.

In the case of backlogging or buffering multiple CSI reports 310 from downlink triggered CSI-RSs 305 or PDSCH or accumulation from CSI-RS resources, compression or cancelation of the CSI report 310 (e.g., the CSI report 310-b) may be desired. In some examples, the UE may send a 1-bit indicator indicating whether the report contents are high correlated (e.g., such that the report may be compressed or canceled) or not, and based on the value of the 1-bit CSI (e.g., the value of the indication 240), a second PUCCH or physical uplink shared channel (PUSCH) resource carrying the CSI report 310 may be determined. For example, a size of the second resource may be based on the value of the bit. That is, the CSI compression indication may be sent in a first stage message and the CSI report 310 for the group 315 may be sent in a second stage in accordance with the value indicated by the CSI compression indication. In some examples, a compressed report may include a report of each other CSI-RS 305 (e.g., one or more channel metrics for every other CSI-RS 305 in the group 315), one report per group 315 of correlated CSI-RSs 305 (e.g., one or more channel metrics for the group 315), and the like.

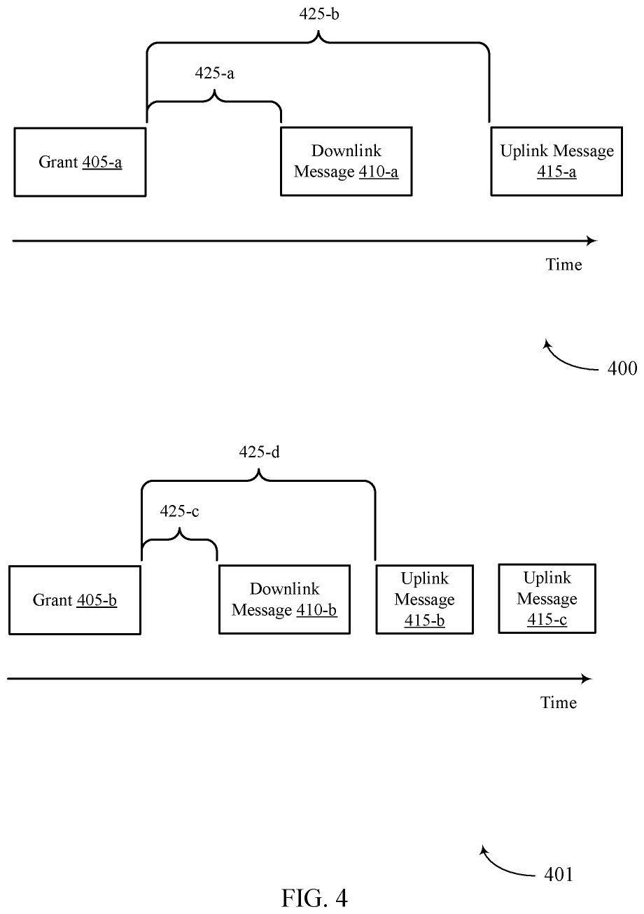

FIG. 4 illustrates examples of a feedback scheme 400 and a feedback scheme 401 that support techniques for channel state information compression in accordance with aspects of the present disclosure. The feedback schemes 400 and 401 may implement or be implemented by aspects of wireless communications systems 100 and 200 as described herein with reference to FIGS. 1 and 2. For example, the feedback schemes 400 and 401 may illustrate communications between a UE 115 and a base station 105, though the techniques described herein may be implemented by any quantity or type of wireless devices.

In some examples, the feedback schemes 400 and 401 may illustrate examples of a downlink grant trigger for aperiodic CSI reports on PUCCH. A downlink triggered aperiodic CSI report (e.g., reports or feedback messages as described herein) may be supported for reduced latency, increased reliability, or both. For example, if a DCI triggered CSI-RS is used, in downlink DCI a CSI trigger field (e.g., a field having a quantity of Z bits) may indicate the CSI trigger state. The trigger state may include a CSI report setting, a CSI-RS resource setting, or both. In some examples, an aperiodic CSI report may be based on PDSCH decoding.

The feedback schemes may include grants 405, which may be examples of a downlink grant via DCI. The feedback schemes may include downlink messages 410, which may be examples of PDSCH messages, and uplink messages 415, which may be examples of PUCCH messages.

In the example of the feedback scheme 400, a base station may transmit a grant 405-a indicating time-frequency resources for the downlink message 410-a. Additionally or alternatively, the grant 405-a may indicate resources for the uplink message 415-a. For example, the grant 405-a may indicate a duration 425-a between the grant 405-a and the downlink message 410-a, a duration 425-b between the grant 405-a and the uplink message 415-a, or both. The uplink message 415-a may be a PUCCH message including both CSI and feedback for the downlink message 410-a, feedback for the grant 405-a, or both (e.g., an acknowledgment (ACK) or a negative ACK (NACK)). That is, the CSI and an ACK may be transmitted in the same PUCCH resource in the feedback scheme 400.

In the example of the feedback scheme 401, a base station may transmit a grant 405-b indicating time-frequency resources for the downlink message 410-b. Additionally or alternatively, the grant 405-b may indicate resources for the uplink message 415-b, the uplink message 415-c, or both. For example, the grant 405-b may indicate a duration 425-c between the grant 405-b and the downlink message 410-b, a duration 425-d between the grant 405-b and the uplink message 415-b, or both. In some examples, the uplink message 415-b may indicate the resources for the uplink message 415-c. The uplink message 415-b may be a PUCCH message including CSI and the uplink message 415-c may be an example of a feedback message (e.g., a PUCCH message including HARQ-ACK feedback, such an ACK or a NACK). That is, the CSI and an ACK may be transmitted in separate PUCCH resources in the feedback scheme 401.

In some examples, the feedback schemes may support triggered PDSCH-CSI. For example, a base station may retrieve a quantity of reports (e.g., M reports) from a UE once an event or other trigger occurs. The UE may send the latest (e.g., unexpired) M (e.g., non-shared) CSI reports once an event occurs. As illustrative examples, the event may be an ACK with a threshold low quality (e.g., poor log likelihood ratios (LLRs), which may use two-stage uplink control information (UCI) as described herein), a NACK or an occurrence of a threshold quantity of NACKs (e.g., X NACKs) for a threshold quantity of transmissions (e.g., L transmissions), an indicator (e.g., DCI) from the base station, or any combination thereof. In some examples, such thresholds and parameters may be configured via RRC or MAC-CE or may be associated with a capability of the UE (e.g., some parameters may be pre-configured at the UE).

A base station may indicate to the UE to report one or more CSI parameters (e.g., channel metrics) from a set of transmissions (e.g., M transmissions that can be buffered at the UE, where a bitmap size of M may be used in the indication to indicate for which transmissions the base station is requesting CSI). In some cases, NACK may trigger the CSI sharing and the UE may maintain a buffer of CSIs corresponding to ACKs, then share M values of the buffered CSIs once a NACK is observed. In some examples, the expiration time for maintaining such a buffer may be based on a timer configured by the base station through RRC or MAC-CE. Additionally or alternatively, the expiration time (e.g., CSI aging) may be based at least in part on a function of a doppler or, in other words, a coherence time of a channel. As an example, if M is 1, then once a NACK is observed by the UE the UE may send the CSI of the 1 transmission associated with the NACK for which CSI is buffered. If M is 2, the UE may send the CSI of the NACKed grant as well as a second, most recent grant before the NACK. If M is 3, the UE may send the 3 latest grants including the NACKed grant, and so on.

In some examples, a UE may receive a set of downlink messages 410 from a base station. The UE may determine a level of correlation between channel metrics of a set of channel metrics associated with the set of downlink messages 410. In some examples, the UE may determine whether the level of correlation satisfies a threshold (e.g., whether the channel metrics are relatively highly correlated). In some examples, the UE may transmit an indication of the level of correlation to the base station. Additionally or alternatively, the UE may select resources for reporting the channel metrics based on the level of correlation. The UE may transmit, and the base station may receive, a report (e.g., an uplink message 415) based on the indication or the selected resources or both. For example, the UE may transmit a compressed report or cancel the report of the channel metrics if the threshold is satisfied. In some cases, the UE may transmit the compressed report over the selected resources configured for communicating compressed reports. In some other examples, the UE may transmit a full report if the threshold is not satisfied. For example, the UE may transmit a full report over selected resources configured for communicating full reports.

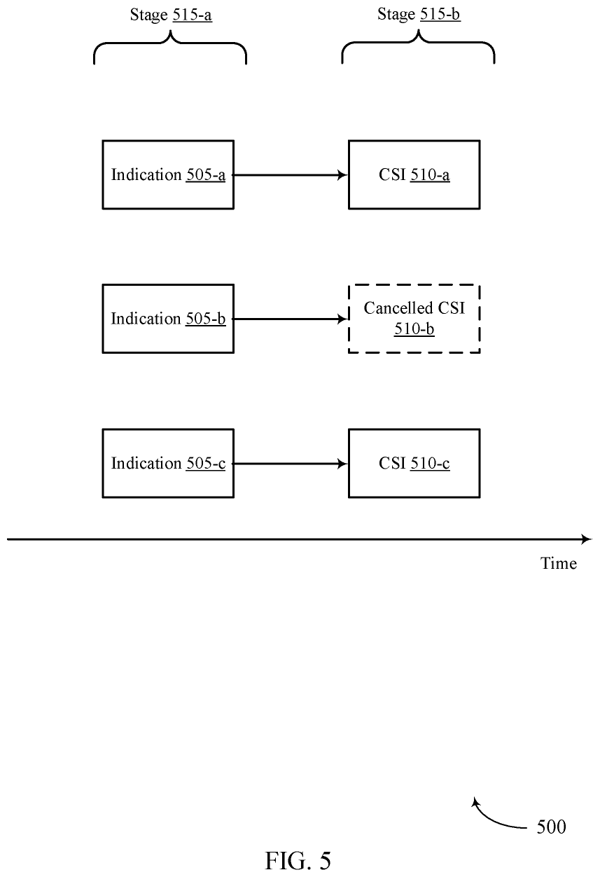

FIG. 5 illustrates an example of a feedback scheme 500 that supports techniques for channel state information compression in accordance with aspects of the present disclosure. The feedback scheme 500 may implement or be implemented by aspects of wireless communications systems 100 and 200 as described herein with reference to FIGS. 1 and 2. For example, the feedback scheme 500 may illustrate communications between a UE 115 and a base station 105, though the techniques described herein may be implemented by any quantity or type of wireless devices.

The feedback scheme 500 may include examples of indications 505 and CSI 510. The indications 505 may be examples of the indication 240 and the CSI 510 may be examples of the first CSI 230 or the second CSI 235 as described with reference to FIG. 2. Generally, the feedback scheme 500 may illustrate an example of two-stage UCI for reporting (or cancelling a report) of CSI 510 based on a level of correlation between a set of channel metrics in the CSI.

For example, two-stage UCI may include two resources or carriers. A first resource may carry the indication 505 in the first stage 515-a (e.g., a carrier or uplink resource may carry a cancellation or high compression bit indicator) and a second resource may carry the CSI 510 in the second stage 515-b (e.g., a second carrier or uplink resource may carry the CSI report). The CSI 510 may be based on a respective indication 505, which may be referred to as a “CancelFlag (highly compressed report)” as described herein with reference to FIG. 2.

As an example, the indication 505-a may include a bit indicating that the report has a low correlation between channel metrics and is not compressed (e.g., if CancelFlag (highly compressed report)=“0,” a size of the report including CSI 510-a may be X bits). As another example, the indication 505-b may include a bit indicating that the report has a high correlation between channel metrics and is canceled (e.g., if CancelFlag (highly compressed report)=“1,” the report including CSI 510-b may be canceled). As yet another example, the indication 505-c may include a bit indicating that the report has a high correlation between channel metrics and is compressed (e.g., if CancelFlag (highly compressed report)=“1,” a size of the report including CSI 510-c may L bits, where L is less than or equal to X bits of an uncompressed report). In examples where the report (e.g., CSI report) is canceled, L may be zero.

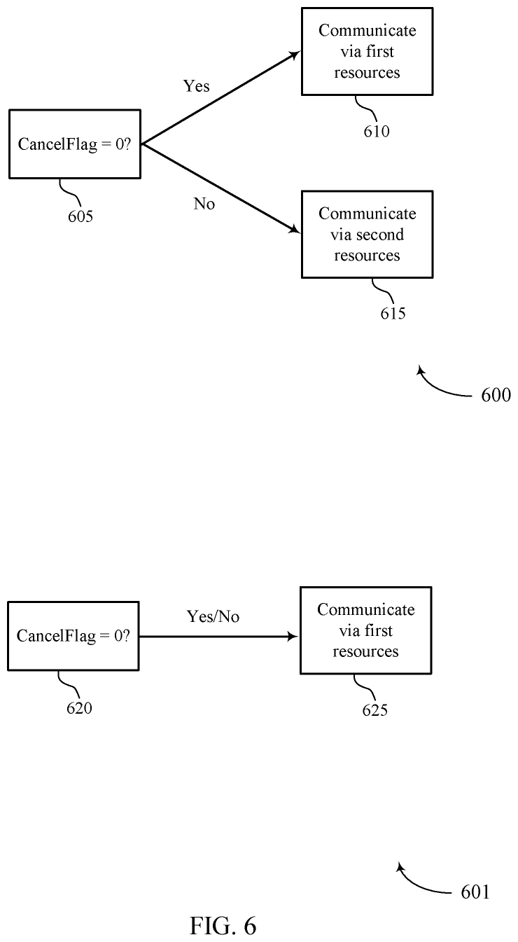

FIG. 6 illustrates examples of a process flow 600 and a process flow 601 in a system that support techniques for channel state information compression in accordance with aspects of the present disclosure. The process flows 600 and 601 may implement or be implemented by aspects of wireless communications systems 100 and 200 as described herein with reference to FIGS. 1 and 2.

In some examples, a base station may configure resources for report messages (e.g., CSI reports) as described with reference to FIG. 2. For example, the base station may define and associate two carriers or uplink resources for CSI reporting based on an indication from the UE (e.g., the indication 240 as described in FIG. 2).

In the example of process flow 600, a UE may transmit an indication of a level of correlation between channel metrics for the report (e.g., an indication of a compression used for the report). As an illustrative example, at 605 a device may determine whether a “CancelFlag” field includes a bit that is 0 or 1. If the bit has a value of 0, at 610 the device may communicate a report via first resources (e.g., a PUCCH or PUSCH resource A configured for report messages with no compression and/or correlation between channel metrics). Alternatively, if the bit has a value of 1, at 615 the device may communicate the report via second resources (e.g., PUCCH resource B configured for compressed reports). Thus, in the process flow 600, different resources may be configured and used for communicating reports with different compression levels. In some examples, using different resources for different compression levels may increase reliability, for example, due to the first stage resource matching the resource used to send the bits of the report.

In the example of process flow 601, at 620 a device may determine whether a “CancelFlag” field includes a bit that is 0 or 1. In the process flow 601, the resources configured for different compression levels may be the same resources. Thus, at 625, the device may communicate the report via the first resources (e.g., the PUCCH or PUSCH resource A). For example, the base station may decode the report using a compression level or scheme indicated by the “CancelFlag” field at 620. By including the indication in the first stage prior to receiving the CSI via the first resources in the second stage, the base station may realize reduced processing overhead by selecting a correct compression scheme for decoding the CSI based on the indication.

Thus, in some examples, if the indication is “0,” a UE may report a full report (e.g., a report with channel metrics for each respective CSI-RS as described in FIG. 2). In such examples the base station may decode both stages of UCI. In some other examples, if the indication is “1,” the UE may cancel a report or generate and transmit a compressed report. In some such examples, the base station may decode the first stage UCI and refrain from decoding or monitoring for the second stage UCI if the report is canceled. The UE may realize power savings if a second stage UCI is canceled (e.g., a quantity of bits of the report, L, is indicated to be 0) or based on the UE determining a quantity of resources to be used based on a payload size of the CSI (e.g., the payload size may be compressed and lower in size and thus the power used by the UE may be reduced). In some examples, canceling the second stage may result in reduced interference at other UEs. Additionally or alternatively, the reliability of CSI transmission may be increased if the quantity of resources is fixed (e.g., the quantity of resources is not based on payload size) and the UE may send a lower quantity of bits on the same amount of resources, thereby increasing the reliability. Thus, the UE may monitor the reporting of CSI based on the contents of the report (e.g., rather than blindly reporting when contents are highly correlated, though such blind reporting may additionally or alternatively be implemented).

Although described with some indication values indicating different processes in the various process flows herein for illustrative clarity, it is to be understood that any value may be used interchangeably, additional values may be used, any quantity of compression or correlation levels may be used, or any combination thereof.

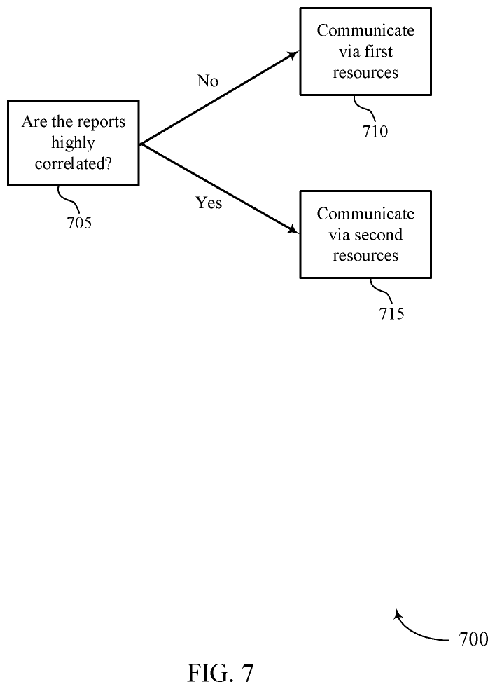

FIG. 7 illustrates an example of a process flow 700 in a system that supports techniques for channel state information compression in accordance with aspects of the present disclosure. The process flow 700 may implement or be implemented by aspects of wireless communications systems 100 and 200 as described herein with reference to FIGS. 1 and 2.

The process flow 700 may illustrate an example of compression techniques without an indication as described herein with reference to FIG. 2. For example, a base station may define and associated two carriers or uplink resources for CSI reporting. Each resource may have a respective payload size based on a level of compression. The UE may report on a resource based on the level of correlation between reports and a corresponding level of compression.

As an illustrative example, at 705 the UE may determine whether the reports (e.g., a set of channel metrics for a set of downlink messages) are relatively highly correlated. For example, the UE may determine a level of correlation of the metrics as described with reference to FIG. 2. The UE may compare the level of correlation to one or more thresholds.

At 710, the UE may determine that the reports are not relatively highly correlated (e.g., the metrics may fail to satisfy the one or more thresholds). In such examples, the UE may communicate via the first resources (e.g., PUCCH resource B or a PUSCH resource configured for reports with relatively low correlation).

At 715, the UE may determine that the reports are relatively highly correlated (e.g., the metrics may satisfy the one or more thresholds). In such examples, the UE may communicate via the second resources (e.g., PUCCH resource A configured for reports with relatively high correlation or compression).

In some examples, the first resources may be different than the second resources. In such examples, a base station may decode each resource with a corresponding level of compression. For example, the base station may decode reports carried via the first resources without using a compression scheme. The base station may decode reports carried via the second resources using a respective compression scheme (e.g., the base station may receive a channel metric for multiple CSI-RSs and determine that the channel metric applies to each of the multiple CSI-RSs based on the compression level associated with the second resources).

In some other examples, the first resources may be different than the second resources. In such examples, instead of two resources, the base station may allow a UE to use the same resources and the base station may perform the decoding twice as described herein.

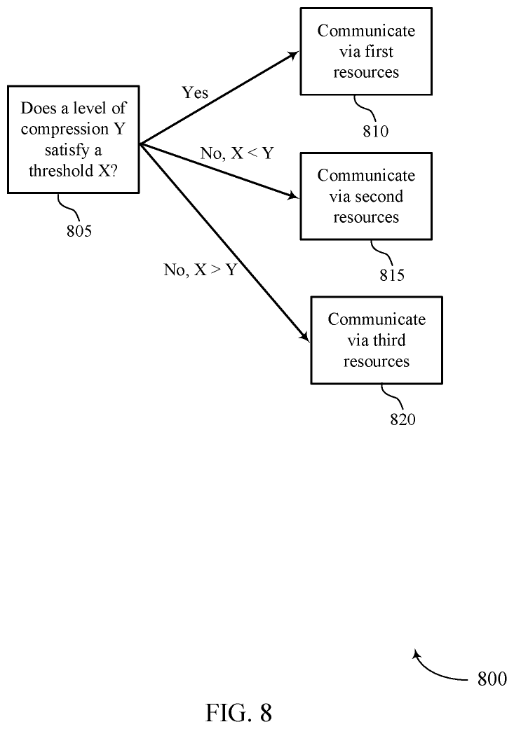

FIG. 8 illustrates an example of a process flow 800 in a system that supports techniques for channel state information compression in accordance with aspects of the present disclosure. The process flow 800 may implement or be implemented by aspects of wireless communications systems 100 and 200 as described herein with reference to FIGS. 1 and 2.

The process flow 800 may illustrate a process for several levels of compression as described herein. For example, in addition or alternative to a 1-bit cancelation or highly compressed report flag indication, the system may support any quantity of compression levels. The different compression levels may be pre-configured at the devices or configured by a base station via control signaling, and a UE may send reports in accordance with the compression levels.

For example, a first compression level may indicate that channel metrics in a report are decimated by 2 (e.g., one or more channel metrics for every other downlink message may be removed from the report), a second compression level may indicate that the channel metrics are decimated by 4 (e.g., one or more channel metrics for every fourth downlink message may be removed from the report), and so on, though any quantity of levels or compression schemes may be used. In some examples, remaining channel metrics (e.g., channel metrics that were maintained in the report) may be applied to the downlink messages for which corresponding channel metrics were removed. Additionally or alternatively, a compression level may be associated with removing one or more parts of a report (e.g., a PMI, RI, CQI, SB CQI, or any combination thereof) from respective reports.

In some examples, each compression level may be mapped to a respective resource (e.g., a PUCCH or PUSCH resource) with a size that depends on a payload size of the compression level. In some cases, multiple compression levels may be mapped to a same resource and a compression level may determine the payload size for the base station. In some other cases, a first stage (e.g., the stage carrying the indication) may be removed and a base station may decode all the resources, where the payload size of each resource may be different.

As an illustrative example, the process flow 800 may show a Y level of compression with three resources configured for reporting various compression levels or ranges of levels, though any quantity of resources may be used. At 805, a UE may determine if a level of compression Y satisfies a threshold compression level X. Stated alternatively, the UE may determine if the level of compression Y is equal to X or not. At 810, the UE may communicate via first resources based on the level of compression Y being equal to X. For example, the UE may communicate via PUCCH or PUSCH resources used for (e.g., configured for) compression levels from level 1 to X.

At 815, the UE may communicate via second resources based on the threshold X being less than Y. For example, the UE may communicate via PUCCH or PUSCH resources used for (e.g., configured for) compression levels from X to Y. At 820, the UE may communicate via third resources based on the threshold X being greater than Y. For example, the UE may communicate via PUCCH or PUSCH resources used for levels of compression that are greater than the level of compression Y.

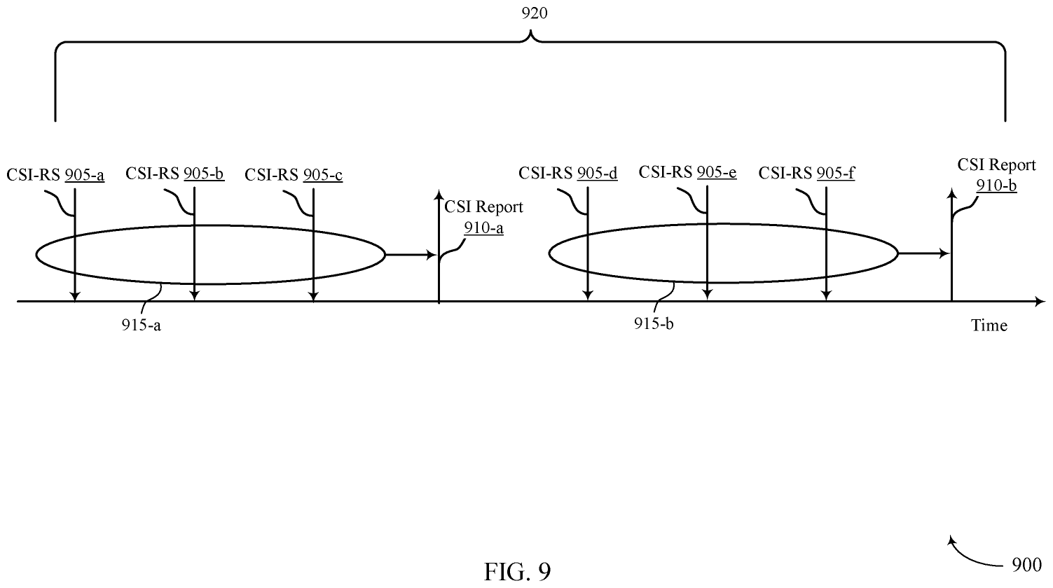

FIG. 9 illustrates an example of a reporting scheme 900 that supports techniques for channel state information compression in accordance with aspects of the present disclosure. The reporting scheme 900 may implement or be implemented by aspects of wireless communications systems 100 and 200 as described herein with reference to FIGS. 1 and 2.

The reporting scheme 900 may include or be an example of a reporting scheme 301 as described with reference to FIG. 3. For example, the reporting scheme 900 may include CSI-RSs 905 (e.g., CSI-RS 905-a, CSI-RS 905-b, CSI-RS 905-c, and so forth), CSI reports 910, and groups 915 (e.g., group 915-a, group 915-b), which may be examples of the corresponding elements described in FIG. 3. Generally, the reporting scheme 900 may illustrate a first stage UCI being applied to multiple CSI compressions.

For example, the CSI report 910-a may include or follow an indication of a level of correlation of the group 915-a, which may be an example of an indication 240 as described herein with reference to FIG. 2. In some examples, an indicated level of correlation (i.e., a level of compression) may be applied for each CSI report 910 in a window 920. For example, if the indication indicates a first level of compression, the CSI report 910-b associated with the group 915-b may be communicated with the first level of compression. The base station may configure the duration of the window 920, for example, using control signaling such as DCI, RRC, or MAC-CE. By configuring the window size (e.g., duration) for applying a same compression level to CSI reports 910 within the window 920, signaling overhead may be reduced in the system.

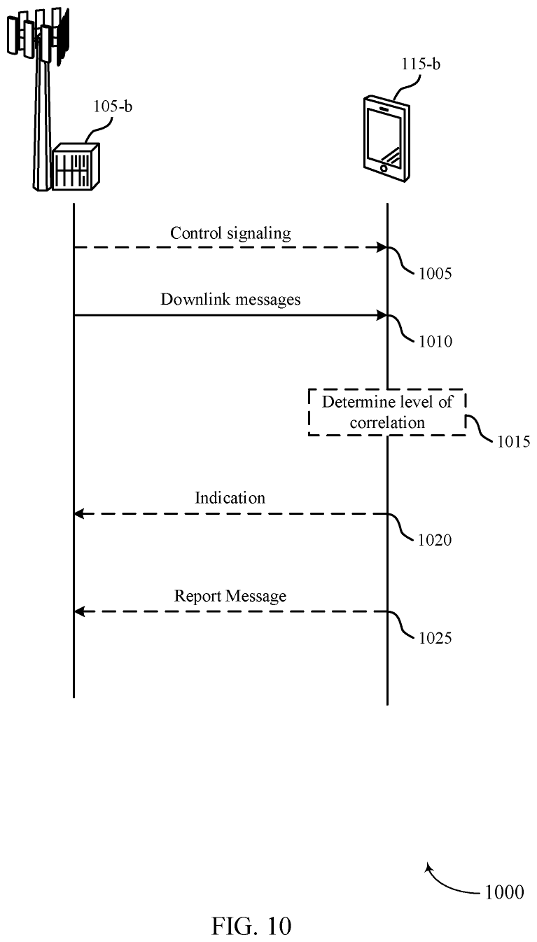

FIG. 10 illustrates an example of a process flow 1000 in a system that supports techniques for channel state information compression in accordance with aspects of the present disclosure. The process flow 1000 may implement or may be implemented by aspects of wireless communications system 100 and 200 as described with reference to FIGS. 1 and 2. For example, the process flow 1000 may be performed by a base station 105-b and a UE 115-b, which may be examples of the corresponding devices described herein.

In some examples, at 1005 the base station may transmit control signaling to the UE 115-b. The control signaling may be RRC signaling, MAC-CE signaling, DCI signaling, or any combination thereof, among other examples of control signaling. The control signaling may configure the UE 115-b with one or more parameters, such as one or more compression levels (e.g., a correspondence or table indicating a value for indicating a respective compression or correlation level), resources for report messages, a window size for applying a same compression level, or any combination thereof, among other examples of parameters. Additionally or alternatively, one or more of the parameters may be pre-configured at the UE 115-b and/or the base station 105-b.

At 1010, the base station 105-b may transmit a set of downlink messages to the UE 115-b. For example, the base station 105-b may transmit downlink messages including reference signals (e.g., CSI-RSs) as described herein. At 1015, the UE 115-b may determine a level of correlation between channel metrics for the downlink messages as described herein with reference to FIG. 2. The UE 115-b may select a level of compression corresponding to the determined level of correlation.

In some examples, at 1020 the UE 115-b may send an indication. The indication may be an example of an indication as described with reference to FIG. 2. For example, the indication may indicate the level of correlation and/or the level of compression for a report message. In some examples, the indication may indicate that a report message is canceled, that a report message is compressed, or that a report message is not compressed, based on the level of correlation between the channel metrics. For example, if the level of correlation satisfies one or more thresholds, the UE may cancel or compress the report message, and if the level of correlation fails to satisfy the one or more thresholds, the UE may transmit a full report message.

In some examples, at 1025 the UE may transmit a report message. The report message may be an example of a report message as described herein (e.g., an uplink message, a feedback message, and the like). For example, the report message may indicate one or more channel metrics for one or more downlink messages in accordance with the level of correlation and/or compression.

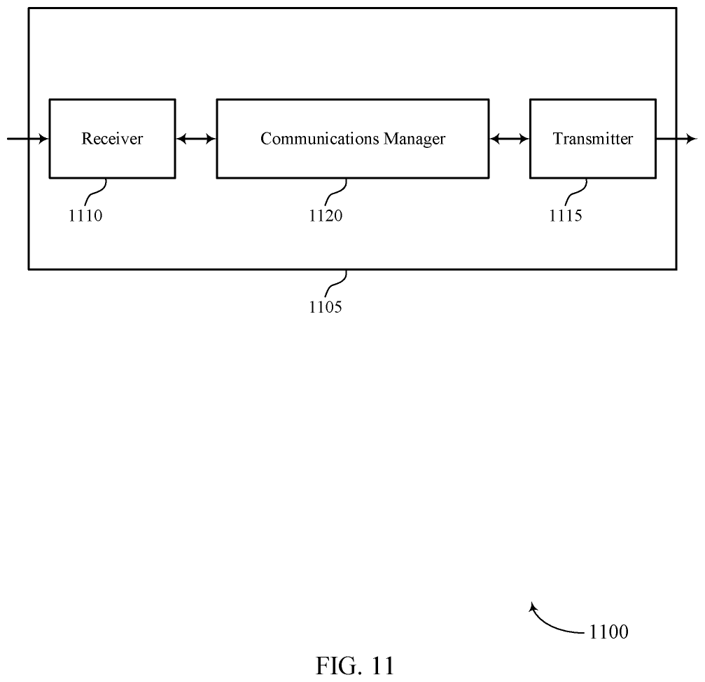

FIG. 11 shows a block diagram 1100 of a device 1105 that supports techniques for channel state information compression in accordance with aspects of the present disclosure. The device 1105 may be an example of aspects of a UE 115 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for receiving information such as packets, user data, control information, or any combination thereof associated with various information channels (e.g., control channels, data channels, information channels related to techniques for channel state information compression). Information may be passed on to other components of the device 1105. The receiver 1110 may utilize a single antenna or a set of multiple antennas.

The transmitter 1115 may provide a means for transmitting signals generated by other components of the device 1105. For example, the transmitter 1115 may transmit information such as packets, user data, control information, or any combination thereof associated with various information channels (e.g., control channels, data channels, information channels related to techniques for channel state information compression). In some examples, the transmitter 1115 may be co-located with a receiver 1110 in a transceiver module. The transmitter 1115 may utilize a single antenna or a set of multiple antennas.

The communications manager 1120, the receiver 1110, the transmitter 1115, or various combinations thereof or various components thereof may be examples of means for performing various aspects of techniques for channel state information compression as described herein. For example, the communications manager 1120, the receiver 1110, the transmitter 1115, or various combinations or components thereof may support a method for performing one or more of the functions described herein.

In some examples, the communications manager 1120, the receiver 1110, the transmitter 1115, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 1120, the receiver 1110, the transmitter 1115, or various combinations or components thereof may be implemented in code (e.g., as communications management software or firmware) executed by a processor. If implemented in code executed by a processor, the functions of the communications manager 1120, the receiver 1110, the transmitter 1115, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 1120 may be configured to perform various operations (e.g., receiving, monitoring, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to receive information, transmit information, or perform various other operations as described herein.

The communications manager 1120 may support wireless communications at a UE in accordance with examples as disclosed herein. For example, the communications manager 1120 may be configured as or otherwise support a means for receiving a set of multiple downlink messages from a base station. The communications manager 1120 may be configured as or otherwise support a means for transmitting, to the base station, a message including an indication of a level of correlation between a set of channel metrics associated with the set of multiple downlink messages. The communications manager 1120 may be configured as or otherwise support a means for communicating with the base station based on transmitting the message including the indication of the level of correlation between the set of channel metrics.

Additionally or alternatively, the communications manager 1120 may support wireless communications at a UE in accordance with examples as disclosed herein. For example, the communications manager 1120 may be configured as or otherwise support a means for receiving, from a base station, control signaling indicating at least a first resource for reporting channel state information having a first level of compression and a second resource for reporting the channel state information having a second level of compression. The communications manager 1120 may be configured as or otherwise support a means for receiving a set of multiple downlink messages from the base station. The communications manager 1120 may be configured as or otherwise support a means for transmitting, to the base station, a message indicating a set of channel metrics associated with the set of multiple downlink messages via the first resource or the second resource based on a level of correlation between the set of channel metrics.

By including or configuring the communications manager 1120 in accordance with examples as described herein, the device 1105 (e.g., a processor controlling or otherwise coupled to the receiver 1110, the transmitter 1115, the communications manager 1120, or a combination thereof) may support techniques for compression or cancellation of CSI reports as described herein. Such techniques may result in reduced power consumption, reduced processing, or both at a modem or processor of the device 1105, among other benefits.

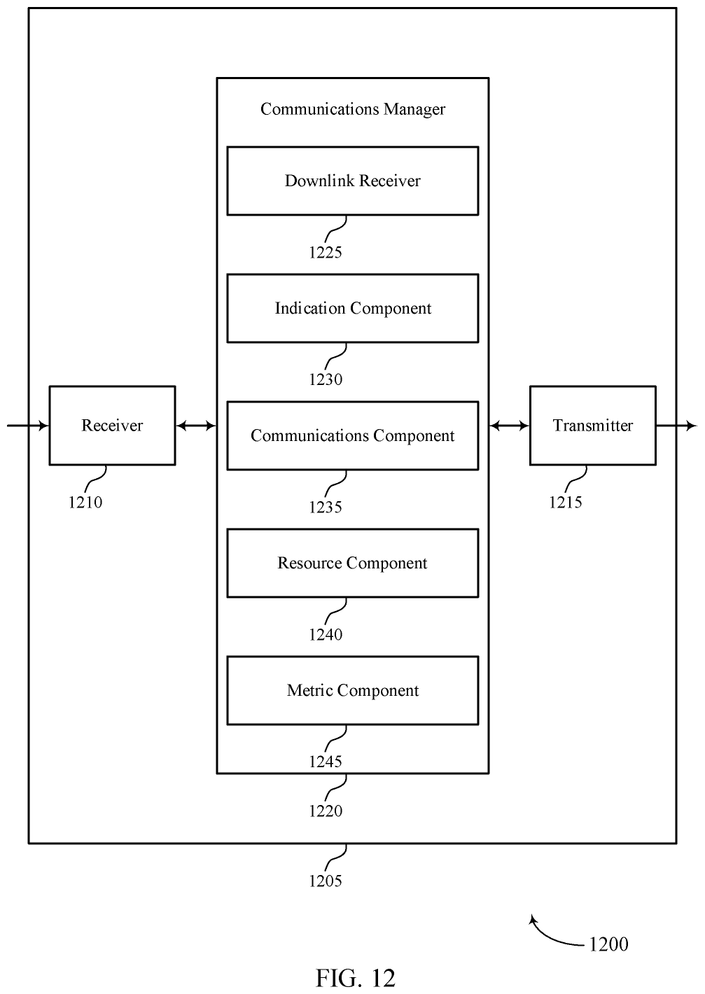

FIG. 12 shows a block diagram 1200 of a device 1205 that supports techniques for channel state information compression in accordance with aspects of the present disclosure. The device 1205 may be an example of aspects of a device 1105 or a UE 115 as described herein. The device 1205 may include a receiver 1210, a transmitter 1215, and a communications manager 1220. The device 1205 may also include a processor. Each of these components may be in communication with one another (e.g., via one or more buses).

The receiver 1210 may provide a means for receiving information such as packets, user data, control information, or any combination thereof associated with various information channels (e.g., control channels, data channels, information channels related to techniques for channel state information compression). Information may be passed on to other components of the device 1205. The receiver 1210 may utilize a single antenna or a set of multiple antennas.

The transmitter 1215 may provide a means for transmitting signals generated by other components of the device 1205. For example, the transmitter 1215 may transmit information such as packets, user data, control information, or any combination thereof associated with various information channels (e.g., control channels, data channels, information channels related to techniques for channel state information compression). In some examples, the transmitter 1215 may be co-located with a receiver 1210 in a transceiver module. The transmitter 1215 may utilize a single antenna or a set of multiple antennas.

The device 1205, or various components thereof, may be an example of means for performing various aspects of techniques for channel state information compression as described herein. For example, the communications manager 1220 may include a downlink receiver 1225, an indication component 1230, a communications component 1235, a resource component 1240, a metric component 1245, or any combination thereof. The communications manager 1220 may be an example of aspects of a communications manager 1120 as described herein. In some examples, the communications manager 1220, or various components thereof, may be configured to perform various operations (e.g., receiving, monitoring, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to receive information, transmit information, or perform various other operations as described herein.

The communications manager 1220 may support wireless communications at a UE in accordance with examples as disclosed herein. The downlink receiver 1225 may be configured as or otherwise support a means for receiving a set of multiple downlink messages from a base station. The indication component 1230 may be configured as or otherwise support a means for transmitting, to the base station, a message including an indication of a level of correlation between a set of channel metrics associated with the set of multiple downlink messages. The communications component 1235 may be configured as or otherwise support a means for communicating with the base station based on transmitting the message including the indication of the level of correlation between the set of channel metrics.

Additionally or alternatively, the communications manager 1220 may support wireless communications at a UE in accordance with examples as disclosed herein. The resource component 1240 may be configured as or otherwise support a means for receiving, from a base station, control signaling indicating at least a first resource for reporting channel state information having a first level of compression and a second resource for reporting the channel state information having a second level of compression. The downlink receiver 1225 may be configured as or otherwise support a means for receiving a set of multiple downlink messages from the base station. The metric component 1245 may be configured as or otherwise support a means for transmitting, to the base station, a message indicating a set of channel metrics associated with the set of multiple downlink messages via the first resource or the second resource based on a level of correlation between the set of channel metrics.

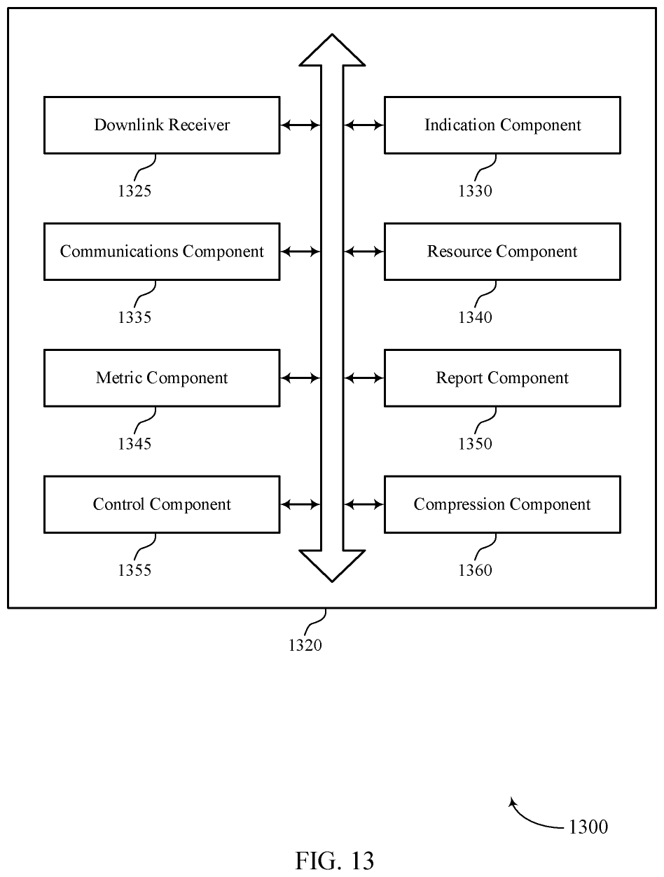

FIG. 13 shows a block diagram 1300 of a communications manager 1320 that supports techniques for channel state information compression in accordance with aspects of the present disclosure. The communications manager 1320 may be an example of aspects of a communications manager 1120, a communications manager 1220, or both, as described herein. The communications manager 1320, or various components thereof, may be an example of means for performing various aspects of techniques for channel state information compression as described herein. For example, the communications manager 1320 may include a downlink receiver 1325, an indication component 1330, a communications component 1335, a resource component 1340, a metric component 1345, a report component 1350, a control component 1355, a compression component 1360, or any combination thereof. Each of these components may communicate, directly or indirectly, with one another (e.g., via one or more buses).

The communications manager 1320 may support wireless communications at a UE in accordance with examples as disclosed herein. The downlink receiver 1325 may be configured as or otherwise support a means for receiving a set of multiple downlink messages from a base station. The indication component 1330 may be configured as or otherwise support a means for transmitting, to the base station, a message including an indication of a level of correlation between a set of channel metrics associated with the set of multiple downlink messages. The communications component 1335 may be configured as or otherwise support a means for communicating with the base station based on transmitting the message including the indication of the level of correlation between the set of channel metrics.

In some examples, to support communicating with the base station, the report component 1350 may be configured as or otherwise support a means for transmitting a report message indicating at least a portion of the set of channel metrics based on whether the level of correlation between the set of channel metrics satisfies a threshold.

In some examples, the report message indicates a subset of channel metrics from the set of channel metrics, a single channel metric for a group of the set of channel metrics, or each channel metric of the set of channel metrics based on whether the level of correlation satisfies the threshold.

In some examples, the report component 1350 may be configured as or otherwise support a means for cancelling a report message for indicating the set of channel metrics based on the level of correlation between the set of channel metrics satisfying a threshold.

In some examples, to support transmitting the message, the indication component 1330 may be configured as or otherwise support a means for transmitting the message including the indication of the level of correlation in a first stage uplink control information message, the message indicating a report size for a second stage uplink control information message including at least a portion of channel state information.

In some examples, the first stage uplink control information message indicates a same compression level for a set of multiple second stage uplink control information messages within a window.

In some examples, the control component 1355 may be configured as or otherwise support a means for receiving control signaling from the base station indicating a duration of the window.

In some examples, the control component 1355 may be configured as or otherwise support a means for receiving control signaling indicating a first set of resources associated with a compressed report for reporting the set of channel metrics and a second set of resources associated with a full report for reporting the set of channel metrics. In some examples, the report component 1350 may be configured as or otherwise support a means for transmitting the compressed report via the first set of resources or the full report via the second set of resources based on the message including the indication.

In some examples, the level of correlation satisfies a threshold, and the report component 1350 may be configured as or otherwise support a means for transmitting a compressed report based on the level of correlation satisfying the threshold. In some examples, the level of correlation satisfies a threshold, and the report component 1350 may be configured as or otherwise support a means for cancelling a full report based on the level of correlation satisfying the threshold.

In some examples, the level of correlation fails to satisfy a threshold, and the report component 1350 may be configured as or otherwise support a means for transmitting a full report based on the level of correlation failing to satisfy the threshold.

In some examples, the indication of the level of correlation corresponds to a first compression level of a set of multiple compression levels.

In some examples, the control component 1355 may be configured as or otherwise support a means for receiving control signaling from the base station indicating the set of multiple compression levels. In some examples, the compression component 1360 may be configured as or otherwise support a means for selecting the first compression level based on the level of correlation, where transmitting the message including the indication is based on the selecting.

In some examples, each of the set of multiple compression levels corresponds to a respective resource, the respective resource having a size associated with a respective compression level of the set of multiple compression levels.

Additionally or alternatively, the communications manager 1320 may support wireless communications at a UE in accordance with examples as disclosed herein. The resource component 1340 may be configured as or otherwise support a means for receiving, from a base station, control signaling indicating at least a first resource for reporting channel state information having a first level of compression and a second resource for reporting the channel state information having a second level of compression. In some examples, the downlink receiver 1325 may be configured as or otherwise support a means for receiving a set of multiple downlink messages from the base station. The metric component 1345 may be configured as or otherwise support a means for transmitting, to the base station, a message indicating a set of channel metrics associated with the set of multiple downlink messages via the first resource or the second resource based on a level of correlation between the set of channel metrics.

In some examples, the first resource includes a different resource than the second resource or a same resource as the second resource.

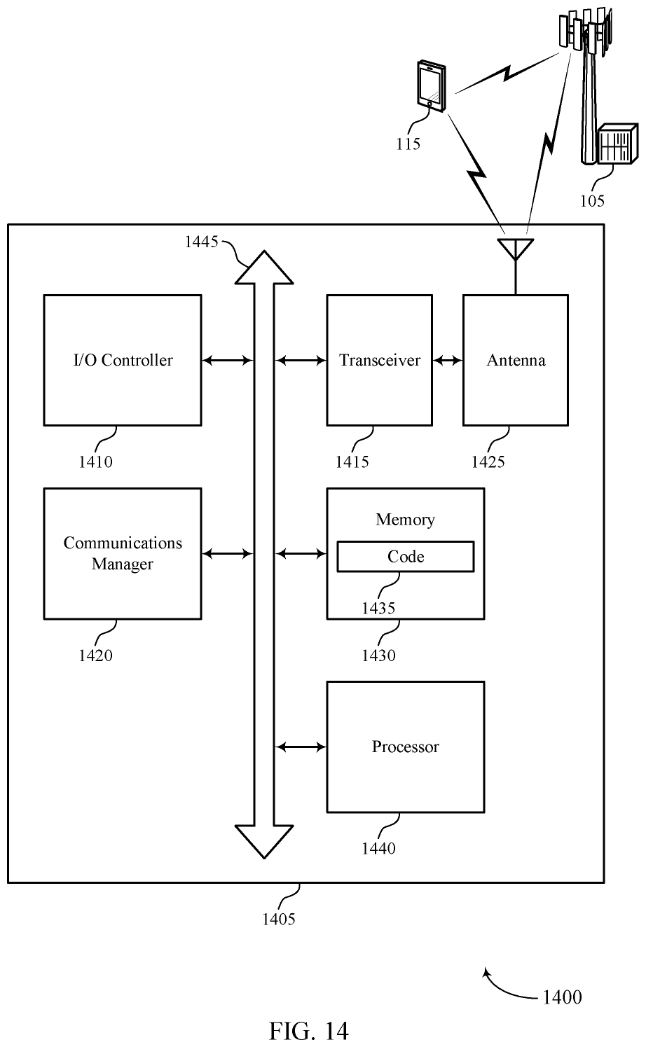

FIG. 14 shows a diagram of a system 1400 including a device 1405 that supports techniques for channel state information compression in accordance with aspects of the present disclosure. The device 1405 may be an example of or include the components of a device 1105, a device 1205, or a UE 115 as described herein. The device 1405 may communicate wirelessly with one or more base stations 105, UEs 115, or any combination thereof. The device 1405 may include components for bi-directional voice and data communications including components for transmitting and receiving communications, such as a communications manager 1420, an input/output (I/O) controller 1410, a transceiver 1415, an antenna 1425, a memory 1430, code 1435, and a processor 1440. These components may be in electronic communication or otherwise coupled (e.g., operatively, communicatively, functionally, electronically, electrically) via one or more buses (e.g., a bus 1445).

The I/O controller 1410 may manage input and output signals for the device 1405. The I/O controller 1410 may also manage peripherals not integrated into the device 1405. In some cases, the I/O controller 1410 may represent a physical connection or port to an external peripheral. In some cases, the I/O controller 1410 may utilize an operating system such as iOS®, ANDROID®, MS-DOS®, MS-WINDOWS®, OS/2®, UNIX®, LINUX®, or another known operating system. Additionally or alternatively, the I/O controller 1410 may represent or interact with a modem, a keyboard, a mouse, a touchscreen, or a similar device. In some cases, the I/O controller 1410 may be implemented as part of a processor, such as the processor 1440. In some cases, a user may interact with the device 1405 via the I/O controller 1410 or via hardware components controlled by the I/O controller 1410.

In some cases, the device 1405 may include a single antenna 1425. However, in some other cases, the device 1405 may have more than one antenna 1425, which may be capable of concurrently transmitting or receiving multiple wireless transmissions. The transceiver 1415 may communicate bi-directionally, via the one or more antennas 1425, wired, or wireless links as described herein. For example, the transceiver 1415 may represent a wireless transceiver and may communicate bi-directionally with another wireless transceiver. The transceiver 1415 may also include a modem to modulate the packets, to provide the modulated packets to one or more antennas 1425 for transmission, and to demodulate packets received from the one or more antennas 1425. The transceiver 1415, or the transceiver 1415 and one or more antennas 1425, may be an example of a transmitter 1115, a transmitter 1215, a receiver 1110, a receiver 1210, or any combination thereof or component thereof, as described herein.

The memory 1430 may include random access memory (RAM) and read-only memory (ROM). The memory 1430 may store computer-readable, computer-executable code 1435 including instructions that, when executed by the processor 1440, cause the device 1405 to perform various functions described herein. The code 1435 may be stored in a non-transitory computer-readable medium such as system memory or another type of memory. In some cases, the code 1435 may not be directly executable by the processor 1440 but may cause a computer (e.g., when compiled and executed) to perform functions described herein. In some cases, the memory 1430 may contain, among other things, a basic I/O system (BIOS) which may control basic hardware or software operation such as the interaction with peripheral components or devices.

The processor 1440 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1440 may be configured to operate a memory array using a memory controller. In some other cases, a memory controller may be integrated into the processor 1440. The processor 1440 may be configured to execute computer-readable instructions stored in a memory (e.g., the memory 1430) to cause the device 1405 to perform various functions (e.g., functions or tasks supporting techniques for channel state information compression). For example, the device 1405 or a component of the device 1405 may include a processor 1440 and memory 1430 coupled to the processor 1440, the processor 1440 and memory 1430 configured to perform various functions described herein.

The communications manager 1420 may support wireless communications at a UE in accordance with examples as disclosed herein. For example, the communications manager 1420 may be configured as or otherwise support a means for receiving a set of multiple downlink messages from a base station. The communications manager 1420 may be configured as or otherwise support a means for transmitting, to the base station, a message including an indication of a level of correlation between a set of channel metrics associated with the set of multiple downlink messages. The communications manager 1420 may be configured as or otherwise support a means for communicating with the base station based on transmitting the message including the indication of the level of correlation between the set of channel metrics.

Additionally or alternatively, the communications manager 1420 may support wireless communications at a UE in accordance with examples as disclosed herein. For example, the communications manager 1420 may be configured as or otherwise support a means for receiving, from a base station, control signaling indicating at least a first resource for reporting channel state information having a first level of compression and a second resource for reporting the channel state information having a second level of compression. The communications manager 1420 may be configured as or otherwise support a means for receiving a set of multiple downlink messages from the base station. The communications manager 1420 may be configured as or otherwise support a means for transmitting, to the base station, a message indicating a set of channel metrics associated with the set of multiple downlink messages via the first resource or the second resource based on a level of correlation between the set of channel metrics.

By including or configuring the communications manager 1420 in accordance with examples as described herein, the device 1405 may support techniques for compression or cancellation of CSI reports as described herein. Such techniques may result in improved user experience related to reduced power consumption and processing, more efficiency utilization of communication resources, or any combination thereof at the device 1405, among other benefits.

In some examples, the communications manager 1420 may be configured to perform various operations (e.g., receiving, monitoring, transmitting) using or otherwise in cooperation with the transceiver 1415, the one or more antennas 1425, or any combination thereof. Although the communications manager 1420 is illustrated as a separate component, in some examples, one or more functions described with reference to the communications manager 1420 may be supported by or performed by the processor 1440, the memory 1430, the code 1435, or any combination thereof. For example, the code 1435 may include instructions executable by the processor 1440 to cause the device 1405 to perform various aspects of techniques for channel state information compression as described herein, or the processor 1440 and the memory 1430 may be otherwise configured to perform or support such operations.

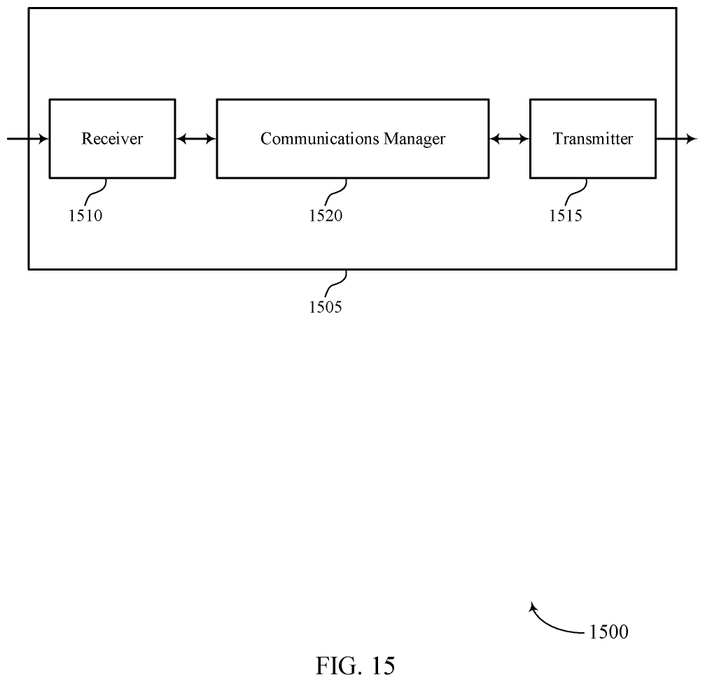

FIG. 15 shows a block diagram 1500 of a device 1505 that supports techniques for channel state information compression in accordance with aspects of the present disclosure. The device 1505 may be an example of aspects of a base station 105 as described herein. The device 1505 may include a receiver 1510, a transmitter 1515, and a communications manager 1520. The device 1505 may also include a processor. Each of these components may be in communication with one another (e.g., via one or more buses).

The receiver 1510 may provide a means for receiving information such as packets, user data, control information, or any combination thereof associated with various information channels (e.g., control channels, data channels, information channels related to techniques for channel state information compression). Information may be passed on to other components of the device 1505. The receiver 1510 may utilize a single antenna or a set of multiple antennas.

The transmitter 1515 may provide a means for transmitting signals generated by other components of the device 1505. For example, the transmitter 1515 may transmit information such as packets, user data, control information, or any combination thereof associated with various information channels (e.g., control channels, data channels, information channels related to techniques for channel state information compression). In some examples, the transmitter 1515 may be co-located with a receiver 1510 in a transceiver module. The transmitter 1515 may utilize a single antenna or a set of multiple antennas.

The communications manager 1520, the receiver 1510, the transmitter 1515, or various combinations thereof or various components thereof may be examples of means for performing various aspects of techniques for channel state information compression as described herein. For example, the communications manager 1520, the receiver 1510, the transmitter 1515, or various combinations or components thereof may support a method for performing one or more of the functions described herein.

In some examples, the communications manager 1520, the receiver 1510, the transmitter 1515, or various combinations or components thereof may be implemented in hardware (e.g., in communications management circuitry). The hardware may include a processor, a DSP, an ASIC, an FPGA or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 1520, the receiver 1510, the transmitter 1515, or various combinations or components thereof may be implemented in code (e.g., as communications management software or firmware) executed by a processor. If implemented in code executed by a processor, the functions of the communications manager 1520, the receiver 1510, the transmitter 1515, or various combinations or components thereof may be performed by a general-purpose processor, a DSP, a CPU, an ASIC, an FPGA, or any combination of these or other programmable logic devices (e.g., configured as or otherwise supporting a means for performing the functions described in the present disclosure).

In some examples, the communications manager 1520 may be configured to perform various operations (e.g., receiving, monitoring, transmitting) using or otherwise in cooperation with the receiver 1510, the transmitter 1515, or both. For example, the communications manager 1520 may receive information from the receiver 1510, send information to the transmitter 1515, or be integrated in combination with the receiver 1510, the transmitter 1515, or both to receive information, transmit information, or perform various other operations as described herein.

The communications manager 1520 may support wireless communications at a base station in accordance with examples as disclosed herein. For example, the communications manager 1520 may be configured as or otherwise support a means for transmitting a set of multiple downlink messages to a UE. The communications manager 1520 may be configured as or otherwise support a means for receiving, from the UE, a message including indication of a level of correlation between a set of channel metrics associated with the set of multiple downlink messages. The communications manager 1520 may be configured as or otherwise support a means for communicating with the UE based on receiving the message including the indication of the level of correlation between the set of channel metrics.

Additionally or alternatively, the communications manager 1520 may support wireless communications at a base station in accordance with examples as disclosed herein. For example, the communications manager 1520 may be configured as or otherwise support a means for transmitting, to a UE, control signaling indicating at least a first resource for reporting channel state information having a first level of compression and a second resource for reporting the channel state information having a second level of compression. The communications manager 1520 may be configured as or otherwise support a means for transmitting a set of multiple downlink messages to the UE. The communications manager 1520 may be configured as or otherwise support a means for receiving, from the UE, message indicating a set of channel metrics associated with the set of multiple downlink messages via the first resource or the second resource based on a level of correlation between the set of channel metrics.

By including or configuring the communications manager 1520 in accordance with examples as described herein, the device 1505 (e.g., a processor controlling or otherwise coupled to the receiver 1510, the transmitter 1515, the communications manager 1520, or a combination thereof) may support techniques for compression or cancellation of CSI reports as described herein. Such techniques may result in improved power utilization, reduced processing or signaling overhead, or any combination thereof at a modem or processor of the device 1505, among other benefits.

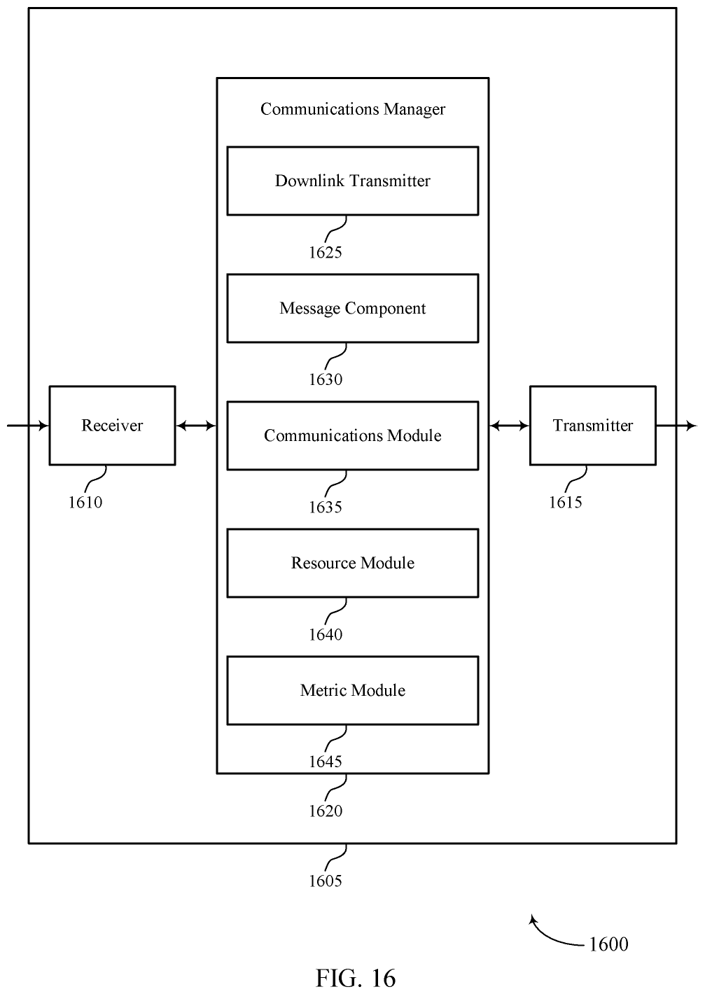

FIG. 16 shows a block diagram 1600 of a device 1605 that supports techniques for channel state information compression in accordance with aspects of the present disclosure. The device 1605 may be an example of aspects of a device 1505 or a base station 105 as described herein. The device 1605 may include a receiver 1610, a transmitter 1615, and a communications manager 1620. The device 1605 may also include a processor. Each of these components may be in communication with one another (e.g., via one or more buses).

The receiver 1610 may provide a means for receiving information such as packets, user data, control information, or any combination thereof associated with various information channels (e.g., control channels, data channels, information channels related to techniques for channel state information compression). Information may be passed on to other components of the device 1605. The receiver 1610 may utilize a single antenna or a set of multiple antennas.

The transmitter 1615 may provide a means for transmitting signals generated by other components of the device 1605. For example, the transmitter 1615 may transmit information such as packets, user data, control information, or any combination thereof associated with various information channels (e.g., control channels, data channels, information channels related to techniques for channel state information compression). In some examples, the transmitter 1615 may be co-located with a receiver 1610 in a transceiver module. The transmitter 1615 may utilize a single antenna or a set of multiple antennas.

The device 1605, or various components thereof, may be an example of means for performing various aspects of techniques for channel state information compression as described herein. For example, the communications manager 1620 may include a downlink transmitter 1625, a message component 1630, a communications module 1635, a resource module 1640, a metric module 1645, or any combination thereof. The communications manager 1620 may be an example of aspects of a communications manager 1520 as described herein. In some examples, the communications manager 1620, or various components thereof, may be configured to perform various operations (e.g., receiving, monitoring, transmitting) using or otherwise in cooperation with the receiver 1610, the transmitter 1615, or both. For example, the communications manager 1620 may receive information from the receiver 1610, send information to the transmitter 1615, or be integrated in combination with the receiver 1610, the transmitter 1615, or both to receive information, transmit information, or perform various other operations as described herein.

The communications manager 1620 may support wireless communications at a base station in accordance with examples as disclosed herein. The downlink transmitter 1625 may be configured as or otherwise support a means for transmitting a set of multiple downlink messages to a UE. The message component 1630 may be configured as or otherwise support a means for receiving, from the UE, a message including indication of a level of correlation between a set of channel metrics associated with the set of multiple downlink messages. The communications module 1635 may be configured as or otherwise support a means for communicating with the UE based on receiving the message including the indication of the level of correlation between the set of channel metrics.

Additionally or alternatively, the communications manager 1620 may support wireless communications at a base station in accordance with examples as disclosed herein. The resource module 1640 may be configured as or otherwise support a means for transmitting, to a UE, control signaling indicating at least a first resource for reporting channel state information having a first level of compression and a second resource for reporting the channel state information having a second level of compression. The downlink transmitter 1625 may be configured as or otherwise support a means for transmitting a set of multiple downlink messages to the UE. The metric module 1645 may be configured as or otherwise support a means for receiving, from the UE, message indicating a set of channel metrics associated with the set of multiple downlink messages via the first resource or the second resource based on a level of correlation between the set of channel metrics.

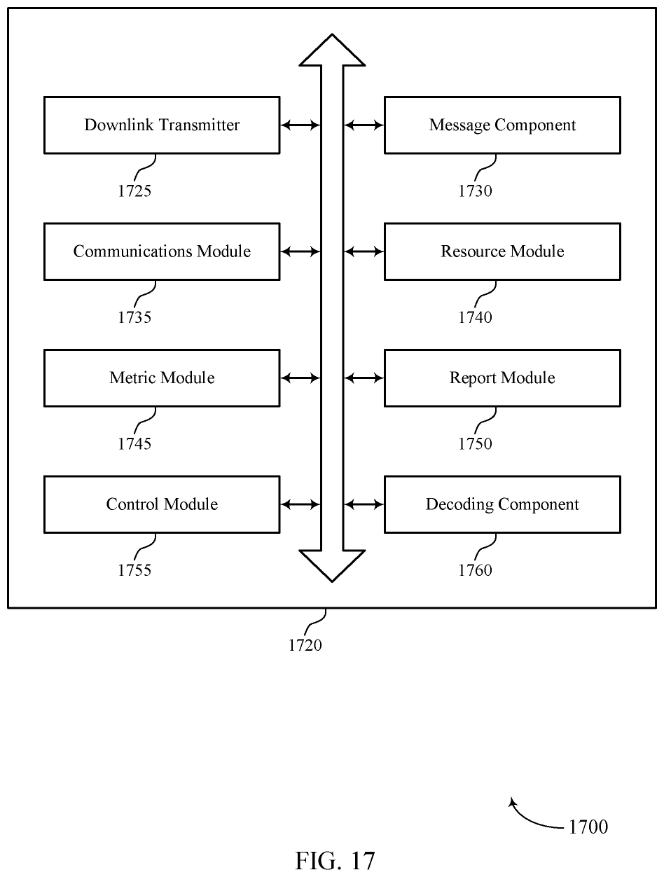

FIG. 17 shows a block diagram 1700 of a communications manager 1720 that supports techniques for channel state information compression in accordance with aspects of the present disclosure. The communications manager 1720 may be an example of aspects of a communications manager 1520, a communications manager 1620, or both, as described herein. The communications manager 1720, or various components thereof, may be an example of means for performing various aspects of techniques for channel state information compression as described herein. For example, the communications manager 1720 may include a downlink transmitter 1725, a message component 1730, a communications module 1735, a resource module 1740, a metric module 1745, a report module 1750, a control module 1755, a decoding component 1760, or any combination thereof. Each of these components may communicate, directly or indirectly, with one another (e.g., via one or more buses).

The communications manager 1720 may support wireless communications at a base station in accordance with examples as disclosed herein. The downlink transmitter 1725 may be configured as or otherwise support a means for transmitting a set of multiple downlink messages to a UE. The message component 1730 may be configured as or otherwise support a means for receiving, from the UE, a message including indication of a level of correlation between a set of channel metrics associated with the set of multiple downlink messages. The communications module 1735 may be configured as or otherwise support a means for communicating with the UE based on receiving the message including the indication of the level of correlation between the set of channel metrics.

In some examples, the report module 1750 may be configured as or otherwise support a means for refraining from monitoring for a report message indicating the set of channel metrics based on the level of correlation between the set of channel metrics satisfying a threshold.

In some examples, to support communicating with the UE, the report module 1750 may be configured as or otherwise support a means for receiving a report message indicating at least a portion of the set of channel metrics based on whether the level of correlation between the set of channel metrics satisfies a threshold.

In some examples, the report message indicates a subset of channel metrics from the set of channel metrics, a single channel metric for a group of the set of channel metrics, or each channel metric of the set of channel metrics based on whether the level of correlation satisfies the threshold.

In some examples, to support receiving the message, the message component 1730 may be configured as or otherwise support a means for receiving the message including the indication of the level of correlation in a first stage uplink control information message, the message indicating a report size for a second stage uplink control information message including at least a portion of channel state information.

In some examples, the first stage uplink control information message indicates a same compression level for a set of multiple second stage uplink control information messages within a window, and the control module 1755 may be configured as or otherwise support a means for transmitting control signaling to the UE indicating a duration of the window.

In some examples, the control module 1755 may be configured as or otherwise support a means for transmitting control signaling indicating a first set of resources associated with a compressed report for reporting the set of channel metrics and a second set of resources associated with a full report for reporting the set of channel metrics. In some examples, the report module 1750 may be configured as or otherwise support a means for receiving the compressed report via the first set of resources or the full report via the second set of resources based on the message including the indication.

In some examples, the level of correlation satisfies a threshold, and the report module 1750 may be configured as or otherwise support a means for receiving a compressed report based on the level of correlation satisfying the threshold. In some examples, the level of correlation satisfies a threshold, and the report module 1750 may be configured as or otherwise support a means for refraining from monitoring for a full report based on the level of correlation satisfying the threshold.

In some examples, the level of correlation fails to satisfy a threshold, and the report module 1750 may be configured as or otherwise support a means for receiving a full report based on the level of correlation failing to satisfy the threshold.

In some examples, the indication of the level of correlation corresponds to a first compression level of a set of multiple compression levels.

In some examples, the control module 1755 may be configured as or otherwise support a means for transmitting control signaling to the UE indicating the set of multiple compression levels.

In some examples, each of the set of multiple compression levels corresponds to a respective resource, the respective resource having a size associated with a respective compression level of the set of multiple compression levels.

Additionally or alternatively, the communications manager 1720 may support wireless communications at a base station in accordance with examples as disclosed herein. The resource module 1740 may be configured as or otherwise support a means for transmitting, to a UE, control signaling indicating at least a first resource for reporting channel state information having a first level of compression and a second resource for reporting the channel state information having a second level of compression. In some examples, the downlink transmitter 1725 may be configured as or otherwise support a means for transmitting a set of multiple downlink messages to the UE. The metric module 1745 may be configured as or otherwise support a means for receiving, from the UE, message indicating a set of channel metrics associated with the set of multiple downlink messages via the first resource or the second resource based on a level of correlation between the set of channel metrics.

In some examples, the first resource includes a different resource than the second resource.

In some examples, the first resource includes a same resource as the second resource, and the decoding component 1760 may be configured as or otherwise support a means for decoding the message indicating the set of channel metrics in accordance with a first compression level. In some examples, the first resource includes a same resource as the second resource, and the decoding component 1760 may be configured as or otherwise support a means for decoding the message indicating the set of channel metrics in accordance with a second compression level.

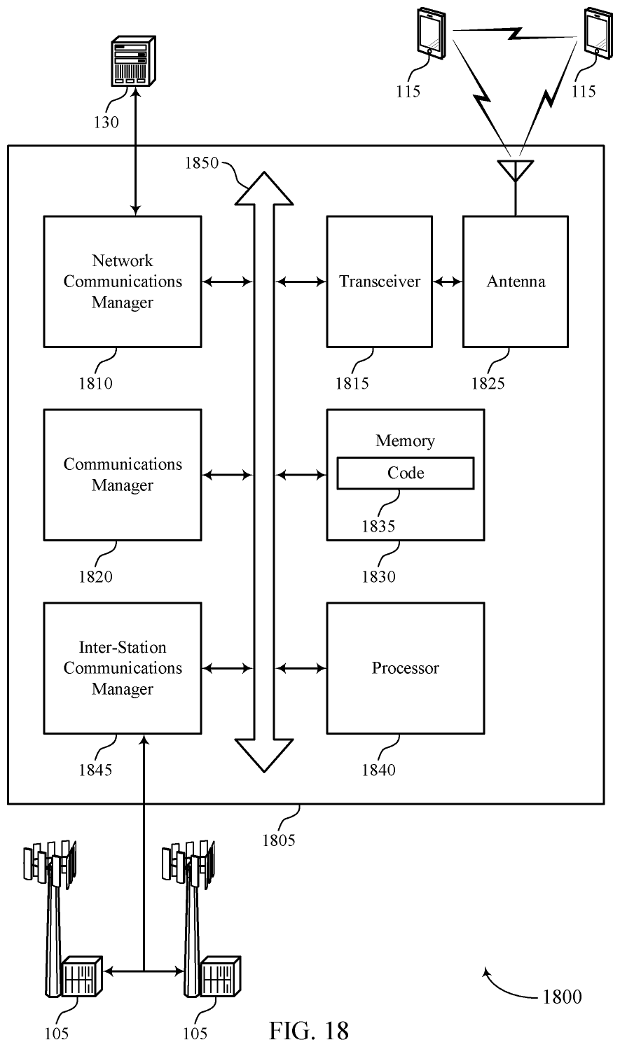

FIG. 18 shows a diagram of a system 1800 including a device 1805 that supports techniques for channel state information compression in accordance with aspects of the present disclosure. The device 1805 may be an example of or include the components of a device 1505, a device 1605, or a base station 105 as described herein. The device 1805 may communicate wirelessly with one or more base stations 105, UEs 115, or any combination thereof. The device 1805 may include components for bi-directional voice and data communications including components for transmitting and receiving communications, such as a communications manager 1820, a network communications manager 1810, a transceiver 1815, an antenna 1825, a memory 1830, code 1835, a processor 1840, and an inter-station communications manager 1845. These components may be in electronic communication or otherwise coupled (e.g., operatively, communicatively, functionally, electronically, electrically) via one or more buses (e.g., a bus 1850).

The network communications manager 1810 may manage communications with a core network 130 (e.g., via one or more wired backhaul links). For example, the network communications manager 1810 may manage the transfer of data communications for client devices, such as one or more UEs 115.

In some cases, the device 1805 may include a single antenna 1825. However, in some other cases the device 1805 may have more than one antenna 1825, which may be capable of concurrently transmitting or receiving multiple wireless transmissions. The transceiver 1815 may communicate bi-directionally, via the one or more antennas 1825, wired, or wireless links as described herein. For example, the transceiver 1815 may represent a wireless transceiver and may communicate bi-directionally with another wireless transceiver. The transceiver 1815 may also include a modem to modulate the packets, to provide the modulated packets to one or more antennas 1825 for transmission, and to demodulate packets received from the one or more antennas 1825. The transceiver 1815, or the transceiver 1815 and one or more antennas 1825, may be an example of a transmitter 1515, a transmitter 1615, a receiver 1510, a receiver 1610, or any combination thereof or component thereof, as described herein.

The memory 1830 may include RAM and ROM. The memory 1830 may store computer-readable, computer-executable code 1835 including instructions that, when executed by the processor 1840, cause the device 1805 to perform various functions described herein. The code 1835 may be stored in a non-transitory computer-readable medium such as system memory or another type of memory. In some cases, the code 1835 may not be directly executable by the processor 1840 but may cause a computer (e.g., when compiled and executed) to perform functions described herein. In some cases, the memory 1830 may contain, among other things, a BIOS which may control basic hardware or software operation such as the interaction with peripheral components or devices.

The processor 1840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1840 may be configured to operate a memory array using a memory controller. In some other cases, a memory controller may be integrated into the processor 1840. The processor 1840 may be configured to execute computer-readable instructions stored in a memory (e.g., the memory 1830) to cause the device 1805 to perform various functions (e.g., functions or tasks supporting techniques for channel state information compression). For example, the device 1805 or a component of the device 1805 may include a processor 1840 and memory 1830 coupled to the processor 1840, the processor 1840 and memory 1830 configured to perform various functions described herein.

The inter-station communications manager 1845 may manage communications with other base stations 105, and may include a controller or scheduler for controlling communications with UEs 115 in cooperation with other base stations 105. For example, the inter-station communications manager 1845 may coordinate scheduling for transmissions to UEs 115 for various interference mitigation techniques such as beamforming or joint transmission. In some examples, the inter-station communications manager 1845 may provide an X2 interface within an LTE/LTE-A wireless communications network technology to provide communication between base stations 105.

The communications manager 1820 may support wireless communications at a base station in accordance with examples as disclosed herein. For example, the communications manager 1820 may be configured as or otherwise support a means for transmitting a set of multiple downlink messages to a UE. The communications manager 1820 may be configured as or otherwise support a means for receiving, from the UE, a message including indication of a level of correlation between a set of channel metrics associated with the set of multiple downlink messages. The communications manager 1820 may be configured as or otherwise support a means for communicating with the UE based on receiving the message including the indication of the level of correlation between the set of channel metrics.

Additionally or alternatively, the communications manager 1820 may support wireless communications at a base station in accordance with examples as disclosed herein. For example, the communications manager 1820 may be configured as or otherwise support a means for transmitting, to a UE, control signaling indicating at least a first resource for reporting channel state information having a first level of compression and a second resource for reporting the channel state information having a second level of compression. The communications manager 1820 may be configured as or otherwise support a means for transmitting a set of multiple downlink messages to the UE. The communications manager 1820 may be configured as or otherwise support a means for receiving, from the UE, message indicating a set of channel metrics associated with the set of multiple downlink messages via the first resource or the second resource based on a level of correlation between the set of channel metrics.

By including or configuring the communications manager 1820 in accordance with examples as described herein, the device 1805 may support techniques for compression or cancellation of CSI reports as described herein. Such techniques may result in improved user experience related to reduced power consumption and processing, more efficiency utilization of communication resources, or any combination thereof at the device 1805, among other benefits.

In some examples, the communications manager 1820 may be configured to perform various operations (e.g., receiving, monitoring, transmitting) using or otherwise in cooperation with the transceiver 1815, the one or more antennas 1825, or any combination thereof. Although the communications manager 1820 is illustrated as a separate component, in some examples, one or more functions described with reference to the communications manager 1820 may be supported by or performed by the processor 1840, the memory 1830, the code 1835, or any combination thereof. For example, the code 1835 may include instructions executable by the processor 1840 to cause the device 1805 to perform various aspects of techniques for channel state information compression as described herein, or the processor 1840 and the memory 1830 may be otherwise configured to perform or support such operations.

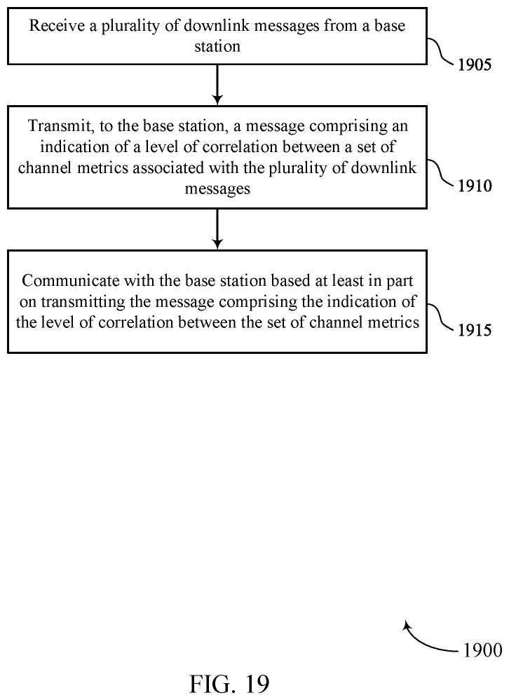

FIG. 19 shows a flowchart illustrating a method 1900 that supports techniques for channel state information compression in accordance with aspects of the present disclosure. The operations of the method 1900 may be implemented by a UE or its components as described herein. For example, the operations of the method 1900 may be performed by a UE 115 as described with reference to FIGS. 1 through 14. In some examples, a UE may execute a set of instructions to control the functional elements of the UE to perform the described functions. Additionally or alternatively, the UE may perform aspects of the described functions using special-purpose hardware.

At 1905, the method may include receiving a set of multiple downlink messages from a base station. The operations of 1905 may be performed in accordance with examples as disclosed herein. In some examples, aspects of the operations of 1905 may be performed by a downlink receiver 1325 as described with reference to FIG. 13.

At 1910, the method may include transmitting, to the base station, a message including an indication of a level of correlation between a set of channel metrics associated with the set of multiple downlink messages. The operations of 1910 may be performed in accordance with examples as disclosed herein. In some examples, aspects of the operations of 1910 may be performed by an indication component 1330 as described with reference to FIG. 13.

At 1915, the method may include communicating with the base station based on transmitting the message including the indication of the level of correlation between the set of channel metrics. The operations of 1915 may be performed in accordance with examples as disclosed herein. In some examples, aspects of the operations of 1915 may be performed by a communications component 1335 as described with reference to FIG. 13.

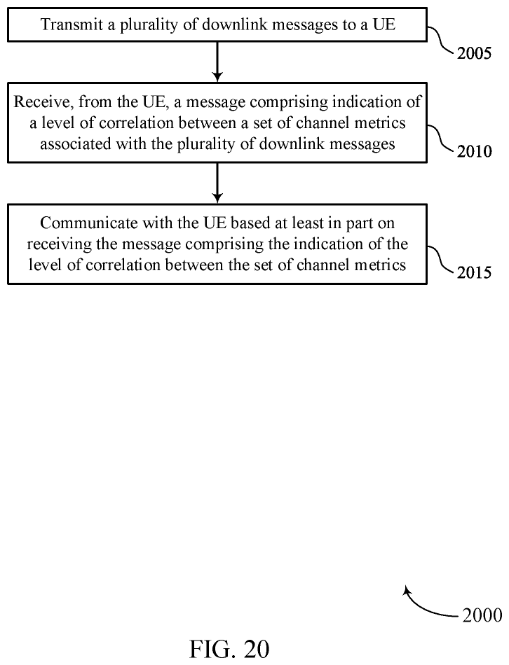

FIG. 20 shows a flowchart illustrating a method 2000 that supports techniques for channel state information compression in accordance with aspects of the present disclosure. The operations of the method 2000 may be implemented by a base station or its components as described herein. For example, the operations of the method 2000 may be performed by a base station 105 as described with reference to FIGS. 1 through 10 and 15 through 18. In some examples, a base station may execute a set of instructions to control the functional elements of the base station to perform the described functions. Additionally or alternatively, the base station may perform aspects of the described functions using special-purpose hardware.

At 2005, the method may include transmitting a set of multiple downlink messages to a UE. The operations of 2005 may be performed in accordance with examples as disclosed herein. In some examples, aspects of the operations of 2005 may be performed by a downlink transmitter 1725 as described with reference to FIG. 17.

At 2010, the method may include receiving, from the UE, a message including indication of a level of correlation between a set of channel metrics associated with the set of multiple downlink messages. The operations of 2010 may be performed in accordance with examples as disclosed herein. In some examples, aspects of the operations of 2010 may be performed by a message component 1730 as described with reference to FIG. 17.

At 2015, the method may include communicating with the UE based on receiving the message including the indication of the level of correlation between the set of channel metrics. The operations of 2015 may be performed in accordance with examples as disclosed herein. In some examples, aspects of the operations of 2015 may be performed by a communications module 1735 as described with reference to FIG. 17.

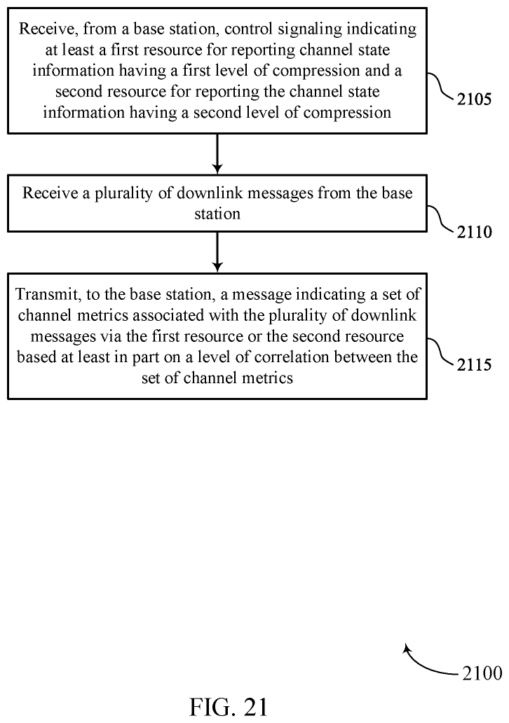

FIG. 21 shows a flowchart illustrating a method 2100 that supports techniques for channel state information compression in accordance with aspects of the present disclosure. The operations of the method 2100 may be implemented by a UE or its components as described herein. For example, the operations of the method 2100 may be performed by a UE 115 as described with reference to FIGS. 1 through 14. In some examples, a UE may execute a set of instructions to control the functional elements of the UE to perform the described functions. Additionally or alternatively, the UE may perform aspects of the described functions using special-purpose hardware.

At 2105, the method may include receiving, from a base station, control signaling indicating at least a first resource for reporting channel state information having a first level of compression and a second resource for reporting the channel state information having a second level of compression. The operations of 2105 may be performed in accordance with examples as disclosed herein. In some examples, aspects of the operations of 2105 may be performed by a resource component 1340 as described with reference to FIG. 13.

At 2110, the method may include receiving a set of multiple downlink messages from the base station. The operations of 2110 may be performed in accordance with examples as disclosed herein. In some examples, aspects of the operations of 2110 may be performed by a downlink receiver 1325 as described with reference to FIG. 13.

At 2115, the method may include transmitting, to the base station, a message indicating a set of channel metrics associated with the set of multiple downlink messages via the first resource or the second resource based on a level of correlation between the set of channel metrics. The operations of 2115 may be performed in accordance with examples as disclosed herein. In some examples, aspects of the operations of 2115 may be performed by a metric component 1345 as described with reference to FIG. 13.

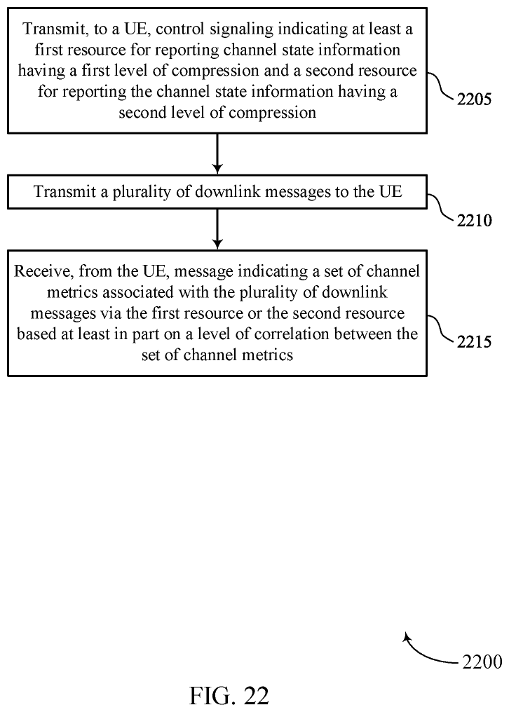

FIG. 22 shows a flowchart illustrating a method 2200 that supports techniques for channel state information compression in accordance with aspects of the present disclosure. The operations of the method 2200 may be implemented by a base station or its components as described herein. For example, the operations of the method 2200 may be performed by a base station 105 as described with reference to FIGS. 1 through 10 and 15 through 18. In some examples, a base station may execute a set of instructions to control the functional elements of the base station to perform the described functions. Additionally or alternatively, the base station may perform aspects of the described functions using special-purpose hardware.

At 2205, the method may include transmitting, to a UE, control signaling indicating at least a first resource for reporting channel state information having a first level of compression and a second resource for reporting the channel state information having a second level of compression. The operations of 2205 may be performed in accordance with examples as disclosed herein. In some examples, aspects of the operations of 2205 may be performed by a resource module 1740 as described with reference to FIG. 17.

At 2210, the method may include transmitting a set of multiple downlink messages to the UE. The operations of 2210 may be performed in accordance with examples as disclosed herein. In some examples, aspects of the operations of 2210 may be performed by a downlink transmitter 1725 as described with reference to FIG. 17.

At 2215, the method may include receiving, from the UE, message indicating a set of channel metrics associated with the set of multiple downlink messages via the first resource or the second resource based on a level of correlation between the set of channel metrics. The operations of 2215 may be performed in accordance with examples as disclosed herein. In some examples, aspects of the operations of 2215 may be performed by a metric module 1745 as described with reference to FIG. 17.

The following provides an overview of aspects of the present disclosure:

Aspect 1: A method for wireless communications at a UE, comprising: receiving a plurality of downlink messages from a base station; transmitting, to the base station, a message comprising an indication of a level of correlation between a set of channel metrics associated with the plurality of downlink messages; and communicating with the base station based at least in part on transmitting the message comprising the indication of the level of correlation between the set of channel metrics.

Aspect 2: The method of aspect 1, wherein communicating with the base station comprises: transmitting a report message indicating at least a portion of the set of channel metrics based at least in part on whether the level of correlation between the set of channel metrics satisfies a threshold.

Aspect 3: The method of aspect 2, wherein the report message indicates a subset of channel metrics from the set of channel metrics, a single channel metric for a group of the set of channel metrics, or each channel metric of the set of channel metrics based at least in part on whether the level of correlation satisfies the threshold.

Aspect 4: The method of any of aspects 1 through 3, further comprising: cancelling a report message for indicating the set of channel metrics based at least in part on the level of correlation between the set of channel metrics satisfying a threshold.

Aspect 5: The method of any of aspects 1 through 4, wherein transmitting the message comprises: transmitting the message comprising the indication of the level of correlation in a first stage uplink control information message, the message indicating a report size for a second stage uplink control information message comprising at least a portion of channel state information.

Aspect 6: The method of aspect 5, wherein the first stage uplink control information message indicates a same compression level for a plurality of second stage uplink control information messages within a window.

Aspect 7: The method of aspect 6, further comprising: receiving control signaling from the base station indicating a duration of the window.

Aspect 8: The method of any of aspects 1 through 7, further comprising: receiving control signaling indicating a first set of resources associated with a compressed report for reporting the set of channel metrics and a second set of resources associated with a full report for reporting the set of channel metrics; and transmitting the compressed report via the first set of resources or the full report via the second set of resources based at least in part on the message comprising the indication.

Aspect 9: The method of any of aspects 1 through 8, wherein the level of correlation satisfies a threshold, the method further comprising: transmitting a compressed report based at least in part on the level of correlation satisfying the threshold; or cancelling a full report based at least in part on the level of correlation satisfying the threshold.

Aspect 10: The method of any of aspects 1 through 9, wherein the level of correlation fails to satisfy a threshold, the method further comprising: transmitting a full report based at least in part on the level of correlation failing to satisfy the threshold.

Aspect 11: The method of any of aspects 1 through 10, wherein the indication of the level of correlation corresponds to a first compression level of a plurality of compression levels.

Aspect 12: The method of aspect 11, further comprising: receiving control signaling from the base station indicating the plurality of compression levels; and selecting the first compression level based at least in part on the level of correlation, wherein transmitting the message comprising the indication is based at least in part on the selecting.

Aspect 13: The method of any of aspects 11 through 12, wherein each of the plurality of compression levels corresponds to a respective resource, the respective resource having a size associated with a respective compression level of the plurality of compression levels.

Aspect 14: A method for wireless communications at a base station, comprising: transmitting a plurality of downlink messages to a UE; receiving, from the UE, a message comprising indication of a level of correlation between a set of channel metrics associated with the plurality of downlink messages; and communicating with the UE based at least in part on receiving the message comprising the indication of the level of correlation between the set of channel metrics.

Aspect 15: The method of aspect 14, further comprising: refraining from monitoring for a report message indicating the set of channel metrics based at least in part on the level of correlation between the set of channel metrics satisfying a threshold.

Aspect 16: The method of any of aspects 14 through 15, wherein communicating with the UE comprises: receiving a report message indicating at least a portion of the set of channel metrics based at least in part on whether the level of correlation between the set of channel metrics satisfies a threshold.

Aspect 17: The method of aspect 16, wherein the report message indicates a subset of channel metrics from the set of channel metrics, a single channel metric for a group of the set of channel metrics, or each channel metric of the set of channel metrics based at least in part on whether the level of correlation satisfies the threshold.

Aspect 18: The method of any of aspects 14 through 17, wherein receiving the message comprises: receiving the message comprising the indication of the level of correlation in a first stage uplink control information message, the message indicating a report size for a second stage uplink control information message comprising at least a portion of channel state information.

Aspect 19: The method of aspect 18, wherein the first stage uplink control information message indicates a same compression level for a plurality of second stage uplink control information messages within a window, the method further comprising: transmitting control signaling to the UE indicating a duration of the window.

Aspect 20: The method of any of aspects 14 through 19, further comprising: transmitting control signaling indicating a first set of resources associated with a compressed report for reporting the set of channel metrics and a second set of resources associated with a full report for reporting the set of channel metrics; and receiving the compressed report via the first set of resources or the full report via the second set of resources based at least in part on the message comprising the indication.

Aspect 21: The method of any of aspects 14 through 20, wherein the level of correlation satisfies a threshold, the method further comprising: receiving a compressed report based at least in part on the level of correlation satisfying the threshold; or refraining from monitoring for a full report based at least in part on the level of correlation satisfying the threshold.

Aspect 22: The method of any of aspects 14 through 21, wherein the level of correlation fails to satisfy a threshold, the method further comprising: receiving a full report based at least in part on the level of correlation failing to satisfy the threshold.

Aspect 23: The method of any of aspects 14 through 22, wherein the indication of the level of correlation corresponds to a first compression level of a plurality of compression levels.

Aspect 24: The method of aspect 23, further comprising: transmitting control signaling to the UE indicating the plurality of compression levels.

Aspect 25: The method of any of aspects 23 through 24, wherein each of the plurality of compression levels corresponds to a respective resource, the respective resource having a size associated with a respective compression level of the plurality of compression levels.

Aspect 26: A method for wireless communications at a UE, comprising: receiving, from a base station, control signaling indicating at least a first resource for reporting channel state information having a first level of compression and a second resource for reporting the channel state information having a second level of compression; receiving a plurality of downlink messages from the base station; and transmitting, to the base station, a message indicating a set of channel metrics associated with the plurality of downlink messages via the first resource or the second resource based at least in part on a level of correlation between the set of channel metrics.

Aspect 27: The method of aspect 26, wherein the first resource comprises a different resource than the second resource or a same resource as the second resource.

Aspect 28: A method for wireless communications at a base station, comprising: transmitting, to a UE, control signaling indicating at least a first resource for reporting channel state information having a first level of compression and a second resource for reporting the channel state information having a second level of compression; transmitting a plurality of downlink messages to the UE; and receiving, from the UE, message indicating a set of channel metrics associated with the plurality of downlink messages via the first resource or the second resource based at least in part on a level of correlation between the set of channel metrics.

Aspect 29: The method of aspect 28, wherein the first resource comprises a different resource than the second resource.

Aspect 30: The method of any of aspects 28 through 29, wherein the first resource comprises a same resource as the second resource, the method further comprising: decoding the message indicating the set of channel metrics in accordance with a first compression level; and decoding the message indicating the set of channel metrics in accordance with a second compression level.

Aspect 31: An apparatus for wireless communications at a UE, comprising a processor; memory coupled with the processor; and instructions stored in the memory and executable by the processor to cause the apparatus to perform a method of any of aspects 1 through 13.

Aspect 32: An apparatus for wireless communications at a UE, comprising at least one means for performing a method of any of aspects 1 through 13.

Aspect 33: A non-transitory computer-readable medium storing code for wireless communications at a UE, the code comprising instructions executable by a processor to perform a method of any of aspects 1 through 13.

Aspect 34: An apparatus for wireless communications at a base station, comprising a processor; memory coupled with the processor; and instructions stored in the memory and executable by the processor to cause the apparatus to perform a method of any of aspects 14 through 25.

Aspect 35: An apparatus for wireless communications at a base station, comprising at least one means for performing a method of any of aspects 14 through 25.

Aspect 36: A non-transitory computer-readable medium storing code for wireless communications at a base station, the code comprising instructions executable by a processor to perform a method of any of aspects 14 through 25.

Aspect 37: An apparatus for wireless communications at a UE, comprising a processor; memory coupled with the processor; and instructions stored in the memory and executable by the processor to cause the apparatus to perform a method of any of aspects 26 through 27.

Aspect 38: An apparatus for wireless communications at a UE, comprising at least one means for performing a method of any of aspects 26 through 27.

Aspect 39: A non-transitory computer-readable medium storing code for wireless communications at a UE, the code comprising instructions executable by a processor to perform a method of any of aspects 26 through 27.

Aspect 40: An apparatus for wireless communications at a base station, comprising a processor; memory coupled with the processor; and instructions stored in the memory and executable by the processor to cause the apparatus to perform a method of any of aspects 28 through 30.

Aspect 41: An apparatus for wireless communications at a base station, comprising at least one means for performing a method of any of aspects 28 through 30.

Aspect 42: A non-transitory computer-readable medium storing code for wireless communications at a base station, the code comprising instructions executable by a processor to perform a method of any of aspects 28 through 30.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communications at a user equipment (UE), comprising:
receiving a plurality of downlink messages from a base station;
transmitting, to the base station, a message comprising an indication of a level of correlation between a set of channel metrics associated with the plurality of downlink messages; and
communicating with the base station based at least in part on transmitting the message comprising the indication of the level of correlation between the set of channel metrics.

2. The method of claim 1, wherein communicating with the base station comprises:
transmitting a report message indicating at least a portion of the set of channel metrics based at least in part on whether the level of correlation between the set of channel metrics satisfies a threshold.

3. The method of claim 2, wherein the report message indicates a subset of channel metrics from the set of channel metrics, a single channel metric for a group of the set of channel metrics, or each channel metric of the set of channel metrics based at least in part on whether the level of correlation satisfies the threshold.

4. The method of claim 1, further comprising:
cancelling a report message for indicating the set of channel metrics based at least in part on the level of correlation between the set of channel metrics satisfying a threshold.

5. The method of claim 1, wherein transmitting the message comprises:
transmitting the message comprising the indication of the level of correlation in a first stage uplink control information message, the message indicating a report size for a second stage uplink control information message comprising at least a portion of channel state information.

6. The method of claim 5, wherein the first stage uplink control information message indicates a same compression level for a plurality of second stage uplink control information messages within a window.

7. The method of claim 6, further comprising:
receiving control signaling from the base station indicating a duration of the window.

8. The method of claim 1, further comprising:
receiving control signaling indicating a first set of resources associated with a compressed report for reporting the set of channel metrics and a second set of resources associated with a full report for reporting the set of channel metrics; and
transmitting the compressed report via the first set of resources or the full report via the second set of resources based at least in part on the message comprising the indication.

9. The method of claim 1, wherein the level of correlation satisfies a threshold, the method further comprising:
transmitting a compressed report based at least in part on the level of correlation satisfying the threshold; or
cancelling a full report based at least in part on the level of correlation satisfying the threshold.

10. The method of claim 1, wherein the level of correlation fails to satisfy a threshold, the method further comprising:
transmitting a full report based at least in part on the level of correlation failing to satisfy the threshold.

11. The method of claim 1, wherein the indication of the level of correlation corresponds to a first compression level of a plurality of compression levels.

12. The method of claim 11, further comprising:
receiving control signaling from the base station indicating the plurality of compression levels; and
selecting the first compression level based at least in part on the level of correlation, wherein transmitting the message comprising the indication is based at least in part on the selecting.

13. The method of claim 11, wherein each of the plurality of compression levels corresponds to a respective resource, the respective resource having a size associated with a respective compression level of the plurality of compression levels.

14. A method for wireless communications at a base station, comprising:
transmitting a plurality of downlink messages to a user equipment (UE);
receiving, from the UE, a message comprising indication of a level of correlation between a set of channel metrics associated with the plurality of downlink messages; and
communicating with the UE based at least in part on receiving the message comprising the indication of the level of correlation between the set of channel metrics.

15. The method of claim 14, further comprising:
refraining from monitoring for a report message indicating the set of channel metrics based at least in part on the level of correlation between the set of channel metrics satisfying a threshold.

16. The method of claim 14, wherein communicating with the UE comprises:
receiving a report message indicating at least a portion of the set of channel metrics based at least in part on whether the level of correlation between the set of channel metrics satisfies a threshold.

17. The method of claim 16, wherein the report message indicates a subset of channel metrics from the set of channel metrics, a single channel metric for a group of the set of channel metrics, or each channel metric of the set of channel metrics based at least in part on whether the level of correlation satisfies the threshold.

18. The method of claim 14, wherein receiving the message comprises:
receiving the message comprising the indication of the level of correlation in a first stage uplink control information message, the message indicating a report size for a second stage uplink control information message comprising at least a portion of channel state information.

19. The method of claim 18, wherein the first stage uplink control information message indicates a same compression level for a plurality of second stage uplink control information messages within a window, the method further comprising:
transmitting control signaling to the UE indicating a duration of the window.

20. The method of claim 14, further comprising:
transmitting control signaling indicating a first set of resources associated with a compressed report for reporting the set of channel metrics and a second set of resources associated with a full report for reporting the set of channel metrics; and
receiving the compressed report via the first set of resources or the full report via the second set of resources based at least in part on the message comprising the indication.

21. The method of claim 14, wherein the level of correlation satisfies a threshold, the method further comprising:
receiving a compressed report based at least in part on the level of correlation satisfying the threshold: or
refraining from monitoring for a full report based at least in part on the level of correlation satisfying the threshold.

22. The method of claim 14, wherein the level of correlation fails to satisfy a threshold, the method further comprising:
receiving a full report based at least in part on the level of correlation failing to satisfy the threshold.

23. The method of claim 14, wherein the indication of the level of correlation corresponds to a first compression level of a plurality of compression levels.

24. The method of claim 23, further comprising:
transmitting control signaling to the UE indicating the plurality of compression levels.

25. The method of claim 23, wherein each of the plurality of compression levels corresponds to a respective resource, the respective resource having a size associated with a respective compression level of the plurality of compression levels.

26. A method for wireless communications at a user equipment (UE), comprising:
receiving, from a base station, control signaling indicating at least a first resource for reporting channel state information having a first level of compression and a second resource for reporting the channel state information having a second level of compression;
receiving a plurality of downlink messages from the base station; and
transmitting, to the base station, a message indicating a set of channel metrics associated with the plurality of downlink messages via the first resource or the second resource based at least in part on a level of correlation between the set of channel metrics.

27. The method of claim 26, wherein the first resource comprises a different resource than the second resource or a same resource as the second resource.

28. A method for wireless communications at a base station, comprising:
transmitting, to a user equipment (UE), control signaling indicating at least a first resource for reporting channel state information having a first level of compression and a second resource for reporting the channel state information having a second level of compression;
transmitting a plurality of downlink messages to the UE; and
receiving, from the UE, message indicating a set of channel metrics associated with the plurality of downlink messages via the first resource or the second resource based at least in part on a level of correlation between the set of channel metrics.

29. The method of claim 28, wherein the first resource comprises a different resource than the second resource.

30. The method of claim 28, wherein the first resource comprises a same resource as the second resource, the method further comprising:
decoding the message indicating the set of channel metrics in accordance with a first compression level; and
decoding the message indicating the set of channel metrics in accordance with a second compression level.
